(19) United States
(12) Patent Application Publication
(10) Pub. No.: US 2012/0162280 A1
(43) Pub. Date: Jun. 28, 2012

(54) SIGNAL PROCESSING DEVICE, SIGNAL PROCESSING METHOD, DISPLAY DEVICE, AND ELECTRONIC APPARATUS

(75) Inventors: Junichi Yamashita, Tokyo (JP); Katsuhide Uchino, Kanagawa (JP)

(73) Assignee: Sony Corporation, Tokyo (JP)

(21) Appl. No.: 13/290,562

(22) Filed: Nov. 7, 2011

(30) Foreign Application Priority Data
Dec. 28, 2010 (JP) 2010-291842

(51) Int. Cl. G09G 5/10

(52) U.S. Cl. 345/690

(57) ABSTRACT

A signal processing device measures an actual luminance of a pixel circuit having a light-emitting device every update period by setting levels of gradation values. A conversion efficiency value is calculated for the light-emitting device to convert a driving current supplied in accordance with a gradation value into a luminance based on the luminance value and a gradation value corresponding to the luminance value. A driving current corresponding to the luminance value is calculated, and a comparison is made of the relationship between the driving current and a gradation value corresponding to the luminance value with the relationship between a driving current and a gradation value when the pixel circuit is in a correction reference state. This is used to calculate a current amount deterioration value of a driving current of the pixel circuit, and generates current amount deterioration characteristic information of the pixel circuit.

### FIELD

The present disclosure relates to a signal processing device and method for correcting deterioration components of light-emitting devices used for displaying images, and a display device and an electronic apparatus each including the signal processing device.

### BACKGROUND

A display device which includes a pixel unit in which a plurality of pixels are arranged in a matrix form and which controls the pixel unit in accordance with image information to be displayed to thereby display images is known. In recent years, a display device in which self-light-emitting devices (for example, organic EL (Electroluminescence) elements) are used in the pixel unit has attracted attention. In such a display device, pixel circuits including organic EL elements are arranged in a matrix form to forma display screen. However, since the organic EL element expresses a gradation by changing the amount of luminescence in accordance with image data to be displayed, the degree of deterioration of the organic EL element is different from one pixel circuit to another. Thus, with the elapse of time, a pixel in which the degree of deterioration is large and a pixel in which the degree of deterioration is small coexist on the display screen. In this case, a phenomenon (commonly known as burn-in) occurs in which a previously displayed image appears to remain on the display screen since the pixel in which the degree of deterioration is large becomes darker than the neighboring pixels.

In order to prevent such a burn-in phenomenon, a display device in which deterioration of a light-emitting device in which the degree of deterioration is small is caused to progress during a non-use period so that the degree of deterioration thereof becomes equal to that of a light-emitting device in which the degree of deterioration is large is proposed (for example, see JP-A-2008-176274).

### SUMMARY

However, in the display device in which deterioration of a light-emitting device in which the degree of deterioration is small is caused to progress during a non-use period so that the degree of deterioration thereof becomes equal to that of a light-emitting device in which the degree of deterioration is large, there is a possibility that deterioration of whole light-emitting devices is caused to progress. Moreover, since correction of burn-in is performed during the non-use period of the display device, there is another problem in that it is not possible to correct burn-in during the use of the display device. Therefore, a method of correcting burn-in by changing the gradation value of a video signal taking deterioration of a light-emitting device itself during the use of the display device into consideration may be considered.

For example, a method in which the gradation value of a video signal is designated in accordance with the degree of deterioration of a pixel circuit that displays the video signal, and a light-emitting device is caused to emit light using the changed video signal may be considered. For example, deterioration information in which a driving time of a general pixel circuit is correlated with the degree of deterioration of luminance may be stored in advance in a device, and the gradation value of a video signal may be changed in response to the elapse of the driving time and in accordance with the amount of deterioration of luminance of respective pixels, which is estimated based on the deterioration information. However, the degree of deterioration of pixels is different from one pixel circuit to another, and the video signal supplied to a pixel circuit is also different from one display target to another. Thus, it is not easy to perform burn-in correction with high accuracy using general deterioration information.

It is therefore desirable to provide a signal processing device and method capable of correcting burn-in with high accuracy by obtaining highly accurate deterioration information and a display device and an electronic apparatus each including the signal processing device.

An embodiment of the present disclosure is directed to a signal processing device including a measuring unit, a conversion efficiency value calculation unit, and a current amount deterioration value calculation unit. The measuring unit measures an actual luminance of a prescribed pixel circuit having a light-emitting device by setting a plurality of levels of gradation values indicating the degree of light emission of the light-emitting device. Moreover, the measuring unit generates measurement information in which the gradation value and the measured luminance value are correlated with each other. The conversion efficiency value calculation unit calculates a conversion efficiency value for the light-emitting device of the prescribed pixel circuit to convert a driving current supplied in accordance with a gradation value into a luminance based on the relationship between the measured luminance value and a gradation value corresponding to the luminance value. The current amount deterioration value calculation unit calculates a driving current corresponding to the measured luminance value using the conversion efficiency value. Subsequently, the current amount deterioration value calculation unit compares the relationship between the driving current and a gradation value corresponding to the luminance value with the relationship between a driving current and a gradation value when the prescribed pixel circuit is in a correction reference state to thereby calculate a current amount deterioration value regarding deterioration of a driving current of the prescribed pixel circuit. Then, the current amount deterioration value calculation unit generates current amount deterioration characteristic information of the prescribed pixel circuit from the current amount deterioration value.

According to the signal processing device of the embodiment of the present disclosure, the measuring unit measures the luminance by setting a plurality of levels of gradation values to the prescribed pixel circuit. The conversion efficiency value calculation unit calculates the conversion efficiency value of the prescribed pixel circuit based on the relationship between the measured luminance value and the gradation value at that time. The current amount deterioration value calculation unit calculates the driving current corresponding to the measured luminance value based on the calculated conversion efficiency value. Moreover, the current amount deterioration value calculation unit compares the gradation value and the driving current value with the relationship between a gradation value and a driving current value when the prescribed pixel circuit is in the correction reference state to thereby calculate the current amount deterioration value regarding deterioration of the driving current of the prescribed pixel circuit. Moreover, the current amount deterioration value calculation unit sets the calculated current amount deterioration value in the current amount deterioration characteristic information.

Another embodiment of the present disclosure is directed to a signal processing method, a display device, and an electronic apparatus which perform the same signal processing as the signal processing device described above.

According to the signal processing device, the signal processing method, the display device, and the electronic apparatus of the embodiment of the present disclosure, the current amount deterioration characteristic information regarding deterioration of the driving current of a pixel circuit is updated based on the measurement information measured using an actual pixel circuit. In this way, it is possible to obtain highly accurate current amount deterioration values based on actual measurement values. Moreover, by performing burn-in correction based on the highly accurate current amount deterioration values, it is possible to perform burn-in correction with high accuracy.

### BRIEF DESCRIPTION OF THE DRAWINGS

FIG. 1 is a conceptual diagram showing a configuration example of a display device according to an embodiment of the present disclosure.

FIG. 2 is a circuit diagram schematically showing a configuration example of a pixel circuit.

FIG. 3 is a graph showing an example of a change in luminance with the elapse of time, of a pixel circuit.

FIG. 4 is a graph showing the relationship between a gradation value of a video signal and a luminance value.

FIG. 5 is diagram showing an example of a hardware configuration of a burn-in correction unit.

FIG. 6 is a diagram showing an example of a functional configuration of the burn-in correction unit.

FIG. 7 is a diagram showing an example of a functional configuration of a deterioration characteristic information generation unit.

FIG. 8 is a graph showing the relationship between the current characteristic and a driving current decrease amount of a pixel circuit.

FIG. 9 is a diagram showing a generation example of deterioration characteristic information.

FIG. 10 is a graph showing an example of current amount deterioration curve based on current amount deterioration characteristic information.

FIG. 11 is a diagram showing a generation example of a conversion efficiency deterioration correction pattern.

FIG. 12 is a diagram showing a generation example of a current amount deterioration correction pattern.

FIG. 13 is a flowchart showing an example of the procedure of a burn-in correction process by the burn-in correction unit.

FIG. 14 is a flowchart showing an example of the procedure of a deterioration characteristic information generation process by the deterioration characteristic information generation unit.

FIG. 15 is a perspective view showing a television set including the display device according to the embodiment of the present disclosure.

FIG. 16 is a perspective view showing a digital still camera including the display device according to the embodiment of the present disclosure.

FIG. 17 is a perspective view showing a notebook personal computer including the display device according to the embodiment of the present disclosure.

FIG. 18 is a schematic diagram showing portable terminal including the display device according to the embodiment of the present disclosure.

FIG. 19 is a perspective view showing a video camera including the display device according to the embodiment of the present disclosure.

### DETAILED DESCRIPTION

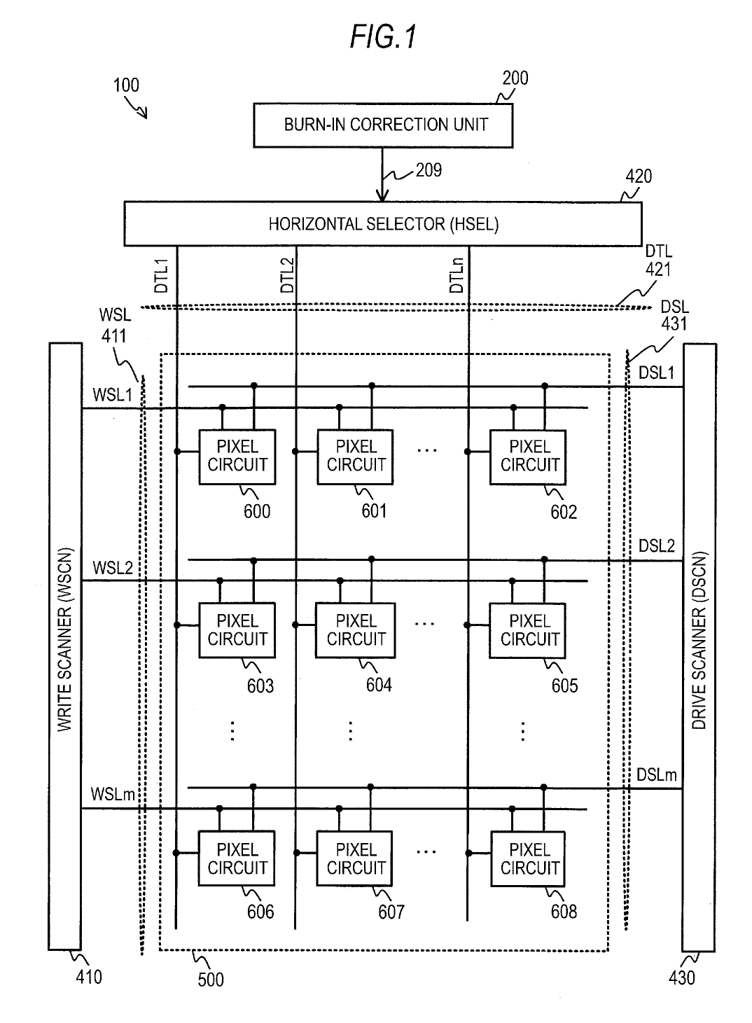

FIG. 1 is a conceptual diagram showing a configuration example of a display device according to an embodiment of the present disclosure. A display device 100 includes a burn-in correction unit 200, a write scanner (WSCN: Write SCaNner) 410, a horizontal selector (HSEL: Horizontal SELector) 420, a drive scanner (DSCN: Drive SCaNner) 430, and a pixel array unit 500.

The pixel array unit 500 includes n×m pixel circuits 600 to 608 (where n and m are integers of 2 or more) which are arranged in a 2-dimensional matrix form. For the sake of convenience, nine pixel circuits 600 to 608 disposed on the first, second, and n-th columns of the first, second, and m-th rows are shown in FIG. 1. The pixel circuits 600 to 608 are connected to the write scanner (WSCN) 410 through scan lines (WSL: Write Scan Line) 411, respectively. Moreover, the pixel circuits 600 to 608 are connected to the horizontal selector (HSEL) 420 through data lines (DTL: DaTa Line) 421, respectively, and to the drive scanner (DSCN) 430 through drive lines (DSL: Drive Scan Line) 431, respectively. In FIG. 1, for the sake of convenience, the numbers of columns (1, . . . , and n) and rows (1, . . . , and m) of connected pixel circuits are assigned to the scan lines (WSL) 411, the data lines (DTL) 421, and the drive lines (DSL) 431. For example, a scan line WSL1, a data line DTL1, and a drive line DSL1 are connected to a pixel circuit 600 disposed on the first column of the first row.

The burn-in correction unit 200 is a signal processing circuit which receives the gradation value of a video signal and corrects burn-in by changing the gradation value of the video signal in accordance with the degree of deterioration of each of the pixel circuits 600 to 608. The burn-in correction unit 200 may be configured as a signal processing device. Here, the gradation value is a driving signal for instructing the pixel circuits 600 to 608 to be driven so as to emit light at a prescribed luminance, and designates the level (step) representing the degree of light emission. For example, the magnitude of emission luminance can be expressed in 256 levels (gradations). It is assumed that emission luminance increases as the signal level of the gradation value increases. In addition, the gradation value of a video signal means the gradation value which is input to the burn-in correction unit 200 as a video signal for display. Here, a gradation value of a video signal of which the emission luminance is 200 nit when the pixel circuit 600 is in the initial state is referred to as a “gradation value 200”. It is assumed that after the elapse of a prescribed period, due to deterioration of the pixel circuit 600, it is possible to obtain an emission luminance of 100 nit even when “gradation value 200” is output. Similarly, it is assumed that the emission luminance as of “gradation value 300” has been deteriorated to 200 nit from 300 nit of the initial state. In this case, the burn-in correction unit 200 changes the gradation value of an output video signal to “gradation value 400”, for example, in order to obtain the luminance (200 nit) of the initial state of “gradation value 200”. The burn-in correction unit 200 supplies the changed video signal to the horizontal selector (HSEL) 420 through a signal line 209. In this way, the pixel circuit 600 is caused to emit light at a luminance of 200 nit to thereby be able to correct burn-in.

The write scanner (WSCN) 410 performs line-sequential scanning wherein the pixel circuits 600 to 608 are sequentially scanned in units of rows. The horizontal selector (HSEL) 420 supplies data signal for setting the magnitude of emission luminance in the pixel circuits 600 to 608 to the pixel circuits 600 to 608 of respective columns in accordance with the line-sequential scanning by the write scanner (WSCN) 410. The drive scanner (DSCN) 430 generates a drive signal for driving the pixel circuits 600 to 608 in units of rows in accordance with the line-sequential scanning by the write scanner (WSCN) 410. Moreover, the pixel circuits 600 to 608 hold the potential of the video signal from the data lines (DTL) 421 based on an operation signal from the scanning lines (WSL) 411 and emit light for a prescribed period in accordance with the held potential.

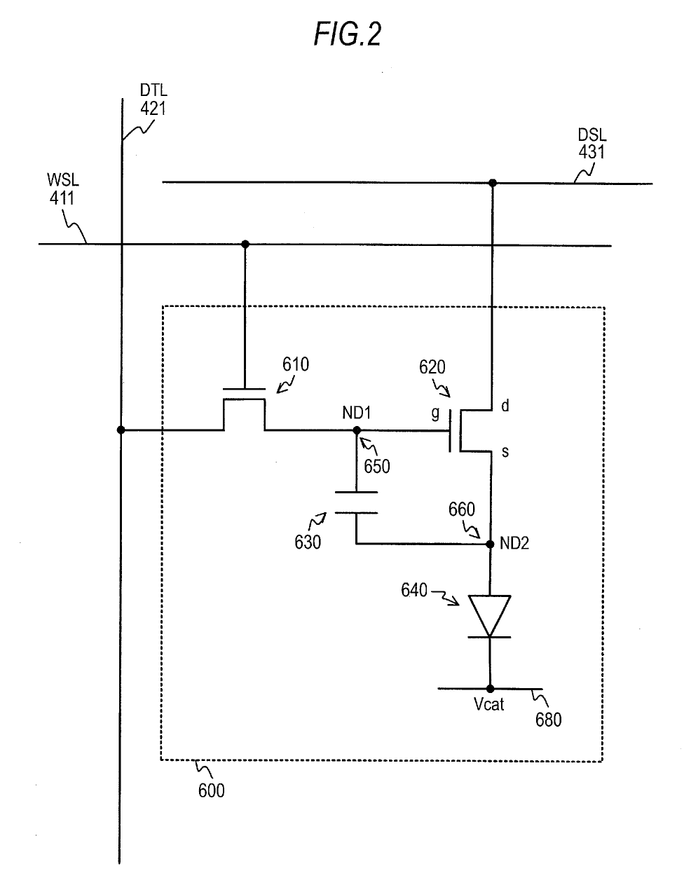

FIG. 2 is a circuit diagram schematically showing a configuration example of a pixel circuit. Although FIG. 2 shows the pixel circuit 600, the other pixel circuits have the same configuration.

The pixel circuit 600 includes a writing transistor 610, a driving transistor 620, a hold capacitor 630, and a light-emitting device 640. In the example of FIG. 2, it is assumed that the writing transistor 610 and the driving transistor 620 are n-channel transistors. In addition, the writing transistor 610 and the driving transistor 620 are not limited to this combination. For example, the transistors 610 and 620 may be p-channel transistors, and may be enhancement, depletion, or dual-gate type transistors.

In the pixel circuit 600, the gate and drain terminal s of the writing transistor 610 are connected to the scanning line (WSL) 411 and the data line (DTL) 421, respectively. Moreover, the source terminal of the writing transistor 610 is connected to the gate terminal (g) of the driving transistor 620 and one electrode (one end) of the hold capacitor 630. In FIG. 2, this connection node is referred to as a first node (ND1) 650. Moreover, the drain terminal (d) of the driving transistor 620 is connected to the drive line (DSL) 431. The source terminal (s) of the driving transistor 620 is connected to the other electrode (the other end) of the hold capacitor 630 and the anode terminal of the light-emitting device 640. In FIG. 2, this connection node is referred to as a second node (ND2) 660.

The writing transistor 610 is a transistor that supplies a data signal from the data line (DTL) 431 to the first node (ND1) 650 in accordance with the scanning signal from the scanning line (WSL) 411. The writing transistor 610 supplies a reference potential of a data signal to one end of the hold capacitor 630 in order to eliminate unevenness in the threshold of the driving transistor 620 of the pixel circuit 600. The reference potential mentioned herein is a fixed potential serving as a reference for causing the hold capacitor 630 to hold a voltage corresponding to the threshold voltage of the driving transistor 620. Moreover, the writing transistor 610 sequentially writes a signal potential of the data signal to one end of the hold capacitor 630 after the voltage corresponding to the threshold voltage of the driving transistor 620 is held in the hold capacitor 630.

The driving transistor 620 outputs a driving current to the light-emitting device 640 based on a signal voltage held in the hold capacitor 630 in accordance with the signal potential in order to cause the light-emitting device 640 to emit light. The driving transistor 620 outputs a driving current corresponding to the signal voltage held in the hold capacitor 630 to the light-emitting device 640 in a state where a driving potential for driving the driving transistor 620 is applied from the drive line (DSL) 431.

The hold capacitor 630 holds a voltage corresponding to the data signal supplied by the writing transistor 610. That is, the hold capacitor 630 performs a role of holding a signal voltage corresponding to the signal potential written by the writing transistor 610.

The light-emitting device 640 emits light in accordance with the magnitude of the driving current output from the driving transistor 620. Moreover, the light-emitting device 640 has an output terminal connected to a cathode line 680. From the cathode line 680, a cathode potential (Vcat) is supplied as a reference potential of the light-emitting device 640. The light-emitting device 640 can be realized by an organic EL element, for example.

In addition, the configuration of the pixel circuit 600 is not limited to the circuit configuration shown in FIG. 2. That is, any circuit configuration which includes the driving transistor 620 and the light-emitting device 640 can be applied to the pixel circuit 600. For example, light emission may be controlled with three or more transistors.

As described above, in the pixel circuit 600 of the display device 100, a driving current corresponding to the signal potential supplied through the data line (DTL) 421 is supplied to the light-emitting device 640, whereby the light-emitting device 640 emits light at a luminance corresponding to the driving current. Thus, when the driving transistor 620, the light-emitting device 640, or the like, which constitute the pixel circuit 600 deteriorates, the amount of the driving current or the amount of emission light changes. As a result, the value of luminance corresponding to a signal potential will be shifted from that of the initial state. If the same amount of shift occurs in all pixel circuits, a so-called burn-in phenomenon will not be caused. However, since an organic EL element expresses a gradation by changing the amount of emission light in accordance with image data to be displayed, the degree of deterioration of the organic EL element is different from one pixel circuit on the display screen to another. Thus, the burn-in phenomenon occurs since a pixel circuit in which the degree of deterioration is large becomes darker than the neighboring pixel circuits.

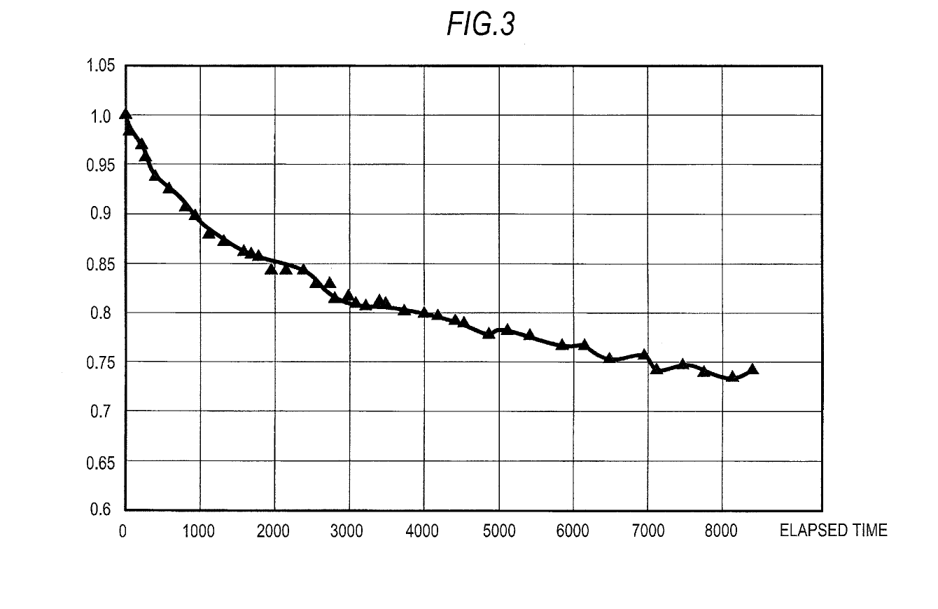

FIG. 3 is a graph showing an example of a change in luminance with the elapse of time, of a pixel circuit. FIG. 3 shows a change in the value (luminance value) of emission luminance with the elapse of time when in a pixel circuit having an organic EL element as a light-emitting device, the light-emitting device 640 is driven in response to a gradation value for emitting light at a luminance of 200 nit. The horizontal axis of FIG. 3 represents the elapsed time accumulated from the initial state. The vertical axis of FIG. 3 represents the ratio of time-varying luminance with the elapse of time to a reference luminance “200 nit” as a correction reference. Here, the initial state means a state when a target pixel circuit is in a correction reference state, and the elapsed time is set to “0” when the target pixel circuit is in the initial state. In the initial state where the elapsed time is “0”, the ratio of the time-varying luminance to the reference luminance is “1.0”. That is, the time-varying luminance is 200 nit in the initial state. It can be understood from FIG. 3 that the luminance decreases as the driving time of the pixel circuit elapses. For example, when a period of 4000 hours elapses, the luminance obtained when the same gradation value as the initial state is output to the pixel circuit is “0.8” of that of the initial state, namely 160 nit. Thus, in order to obtain a luminance of 200 nit with the pixel circuit after the elapse of 4000 hours, a correction process of adding a correction amount corresponding to a luminance deterioration amount to the gradation value of a video signal maybe performed. In this way, the pixel circuit will be able to emit light at an apparent luminance of 200 nit.

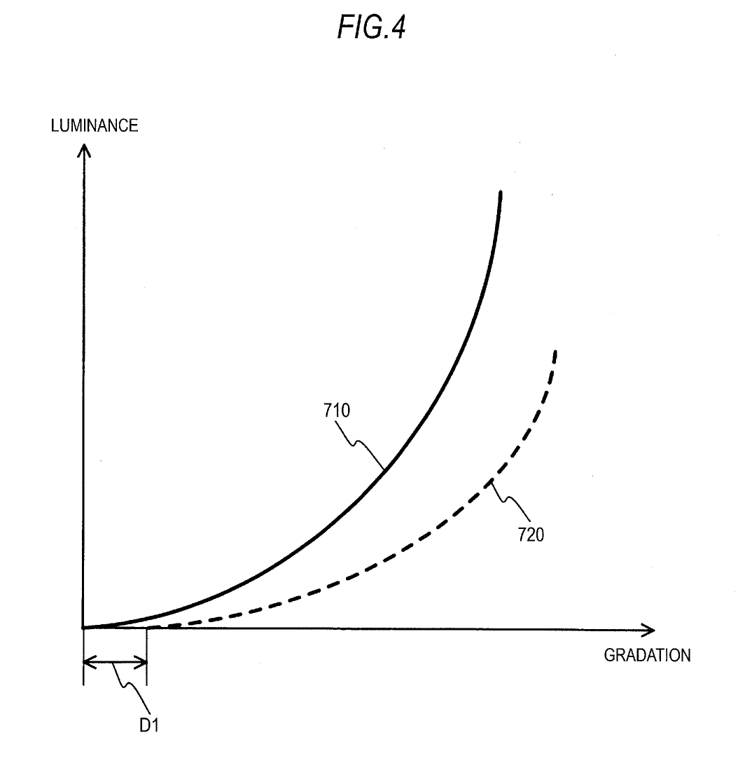

FIG. 4 is a graph showing the relationship between a gradation value of a video signal and a luminance value. The horizontal axis of FIG. 4 represents the gradation value of a video signal input to the burn-in correction unit 200, and the vertical axis represents the luminance values obtained in the pixel circuits 600 to 608. Moreover, a pixel characteristic curve (initial) 710 represents the relationship between an input gradation value and a luminance value in a pixel circuit in the initial state, and a pixel characteristic curve (deteriorated) 720 represents the relationship between an input gradation value and a luminance value in a pixel circuit after the elapse of time from the initial state.

The pixel characteristic curve (initial) 710 will be described. The pixel characteristic curve (initial) 710 is expressed by the following quadratic function, for example.

L=A×S² (1)

Here, “L” is a luminance value. Moreover, “A” is a coefficient (hereinafter referred to as a conversion efficiency) determined based on conversion efficiency when converting a driving current supplied to the light-emitting device 640 into a luminance. Furthermore, “S²” is a value calculated using the square characteristics of the driving transistor 620 and is a value corresponding to the driving current supplied to the light-emitting device 640. As above, the luminance value L can be calculated by multiplying the conversion efficiency A of the light-emitting device 640 to the driving current S².

The pixel characteristic curve (deteriorated) 720 has a gentler slope than the pixel characteristic curve (initial) 710 since the light-emitting device 640 deteriorates with the elapse of time, and the conversion efficiency of converting a driving current to a luminance deteriorates. Moreover, the pixel characteristic curve (deteriorated) 720 is shifted rightward by an amount corresponding to a driving current amount decrease component D1 in the horizontal axis direction as compared to the pixel characteristic curve (initial) 710. The driving current amount decrease component D1 is a component indicating the amount (driving current decrease amount) of decrease in the driving current and occurs due to deterioration of the driving transistor 620 and the light-emitting device 640. That is, when the driving transistor 620 deteriorates, the amount of a driving current supplied to the light-emitting device 640 in accordance with a signal voltage decreases. Moreover, when the light-emitting device 640 deteriorates, since the threshold voltage of the light-emitting device 640 increases, the signal voltage decreases and the amount of the driving current decreases. As above, the driving current amount decrease component D1 occurs due to a decrease in the driving current amount supplied in accordance with the signal voltage and a decrease in the signal voltage.

In the pixel characteristic curve (initial) 710 expressed by Equation (1), the pixel characteristic curve (deteriorated) 720 in a state where the driving transistor 620 and the light-emitting device 640 deteriorate is expressed by the following quadratic function.

Ld=Ad×(S−ΔS)² (2)

Here, “Ld” is the luminance value of a pixel circuit serving as a correction target. Moreover, “Ad” is a coefficient (conversion efficiency) determined based on conversion efficiency when converting a driving current supplied to the light-emitting device 640 of a pixel circuit serving as a correction target into a luminance. Furthermore, “ΔS” is the driving current amount decrease component D1 in FIG. 4. Furthermore, “(S−ΔS)²” represents a driving current supplied to the light-emitting device 640 when the driving current amount decrease component D1 is taken into consideration. As above, the deteriorated luminance value Ld can be calculated by the driving current (S−ΔS)² in which the deteriorated conversion efficiency Ad and the driving current amount decrease component D1 are taken into consideration.

As described above, when a pixel circuit deteriorates with the use of the display device 100, deterioration of a conversion efficiency and decrease of a driving current progress at the same time, and a luminance value corresponding to the gradation value of a video signal decreases. In the following description, a phenomenon in which a conversion efficiency deteriorates with the elapse of the use time of a pixel circuit will be referred to as a conversion efficiency deterioration, and a phenomenon in which the driving current decreases with the elapse of the use time will be referred to as a current amount deterioration. In the pixel characteristic graph shown in FIG. 4, the conversion efficiency deterioration corresponds to a decrease in slope of the pixel characteristic curve, and the current amount deterioration corresponds to a shift in the gradation direction of the pixel characteristic curve.

The burn-in correction unit 200 of the display device 100 uses the pixel characteristic curve (initial) 710 in a correction reference state (for example, in the initial state where no deterioration occurs) as a reference and corrects an input gradation value so that the pixel characteristic curve (deteriorated) 720 of a deteriorated pixel circuit is identical to the reference (the pixel characteristic curve 710). Although details are described later, in the burn-in correction unit 200 prepares a conversion efficiency deterioration correction pattern for correcting a conversion efficiency deterioration and a current amount deterioration correction pattern for correcting a current amount deterioration and corrects the gradation value of a video signal of a deteriorated pixel circuit. As above, by classifying deterioration components into an efficiency deterioration and a current amount deterioration and correcting the deterioration components, it is possible to realize correction of higher accuracy.

Here, correction of a conversion efficiency deterioration component will be described. In correction of the conversion efficiency deterioration component, the gradation of a video signal is changed based on the following expression. A corrected gradation value Gout is calculated by the following equation based on Equations (1) and (2).

Gout=(ΔA)^{-1/2}×Gin (3)

ΔA=Ad/A (4)

Here, “Gout” is a gradation value of a video signal, corrected by the burn-in correction unit 200. Moreover, “Gin” is a gradation value of a video signal before corrected by the burn-in correction unit 200. Furthermore, “ΔA” is the value (conversion efficiency deterioration value) of a fraction expressing the ratio of conversion efficiencies in which the conversion efficiency Ad of a correction target pixel circuit is the numerator and the conversion efficiency A of a pixel circuit in the initial state is the denominator. In addition, in Equations (3) and (4), the driving current decrease amount ΔS is not taken into consideration. In other words, “Gout” is a gradation value needed for a pixel circuit, in which the conversion efficiency value deteriorates to Ad, to obtain the luminance value L which is obtained when a gradation value Gin is input to the pixel circuit in the initial state when the driving current decrease amount ΔS is not taken into consideration.

In order to change the input gradation value based on Equation (3), the burn-in correction unit 200 holds information on deterioration of each of the pixel circuits 600 to 608 and calculates a conversion efficiency value of each of the pixel circuits 600 to 608 based on the deterioration information. Moreover, the burn-in correction unit 200 calculates AA and changes the gradation of a video signal based on the calculated ΔA to thereby generate the value (corrected gradation value) of the corrected gradation of the video signal. As above, correction based on the conversion efficiency deterioration value (ΔA) based on Equation (3) will be referred to as conversion efficiency deterioration correction. The conversion efficiency deterioration correction corresponds to correction of the slope of the pixel characteristic curve.

However, in the conversion efficiency deterioration correction, the effect of the driving current decrease amount ΔS is not taken into consideration. Thus, the burn-in correction unit 200 further performs correction taking the effect of ΔS into consideration. Here, “ΔS” corresponds to the driving current amount decrease component D1 in the example of the pixel characteristic curve shown in FIG. 4. Thus, the gradation value Gout after the current amount deterioration correction can be calculated by the following equation based on Equation (3).

Gout=(ΔA)^{-1/2}×Gin+ΔS (5)

That is, after correcting the slope of the pixel characteristic curve by the conversion efficiency deterioration correction, by shifting the corrected gradation value by ΔS, the pixel characteristic curve after correction is made identical to the pixel characteristic curve (initial) 710. Such correction based on the driving current decrease amount ΔS will be referred to current amount deterioration correction. The current amount deterioration correction corresponds to correction of the shift in gradation of the pixel characteristic curve.

Hereinafter, a configuration of the burn-in correction unit will be described in detail.

### [Configuration Example of Burn-in Correction Unit]

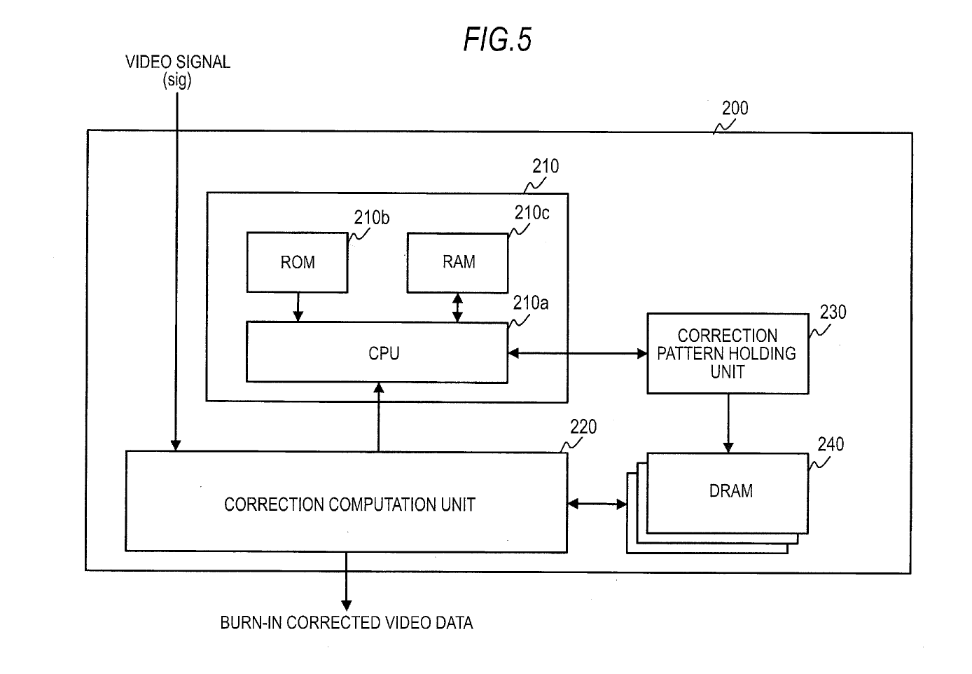

First, a hardware configuration example of the burn-in correction unit 200 will be described. FIG. 5 is a diagram showing an example of a hardware configuration of the burn-in correction unit.

The burn-in correction unit 200 includes a correction pattern generation unit 210, a correction computation unit 220, a correction pattern holding unit 230, and a DRAM (Dynamic Random Access Memory) 240. The burn-in correction unit 200 corrects the gradation value of an input video signal and outputs the corrected video signal to the pixel array unit 500 as burn-in correction video data.

The correction pattern generation unit 210 performs a process of generating correction patterns for correcting conversion efficiency deterioration and current amount deterioration with the aid of a CPU (Central Processing Unit) 210a. The CPU 210a is connected through an internal bus to a ROM (Read Only Memory) 210b, a RAM (Random Access Memory) 210c, and peripheral devices such as the correction computation unit 220 and the correction pattern holding unit 230.

Various data necessary for processing by the CPU 210a are stored in the RAM 210c. OS programs, application programs, and various data are stored in the ROM 210b.

The correction computation unit 220 acquires the gradation value of a video signal and performs a burn-in correction process. The correction computation unit 220 is configured by an ASIC (Application Specific Integrated Circuit) or an FPGA (Field Programmable Gate Array) in order to perform processing at a high speed.

The correction pattern holding unit 230 is a storage unit that holds correction patterns generated by the correction pattern generation unit 210. For example, the correction pattern holding unit 230 is configured by a semiconductor storage device such as a flash memory.

The DRAM 240 is a storage unit that holds correction patterns which are referenced by the correction computation unit 220. For example, the DRAM 240 is configured by a memory capable of performing processing at a relatively high speed such as a DDR SDRAM (Double-Data-Rate Synchronous DRAM).

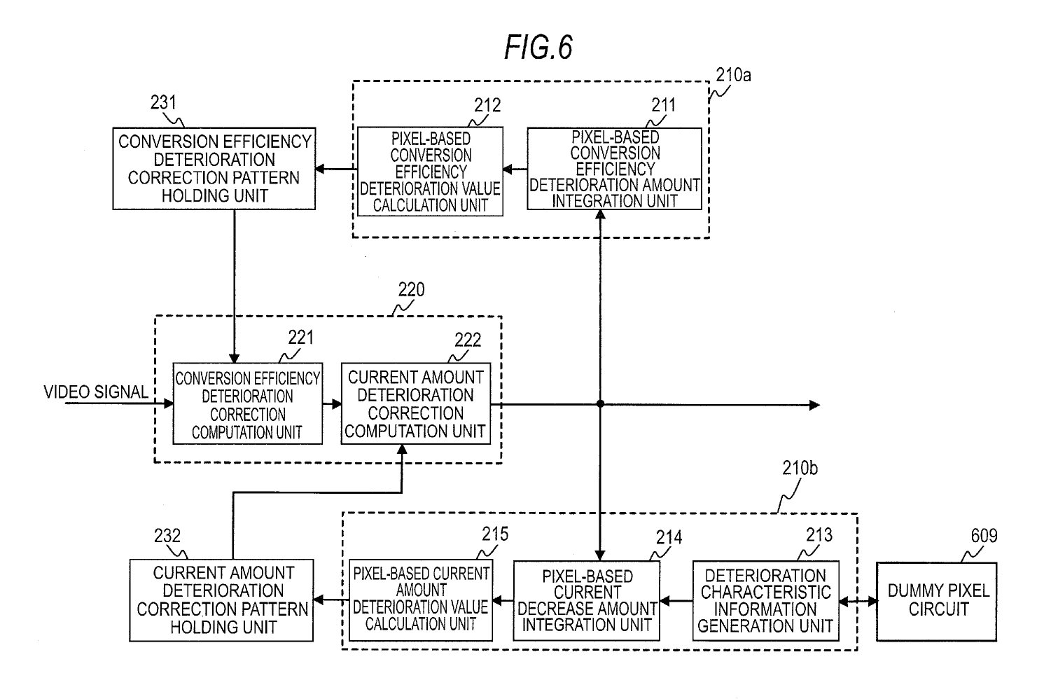

Next, a functional configuration example of the burn-in correction unit 200 will be described. FIG. 6 is a diagram showing an example of a functional configuration of the burn-in correction unit.

The correction pattern generation unit 210, the correction computation unit 220, and the correction pattern holding unit 230 of the burn-in correction unit 200 shown in FIG. 5 each include a processing unit that performs conversion efficiency deterioration correction and a processing unit that performs current amount deterioration correction. The correction pattern generation unit 210 includes a conversion efficiency deterioration correction pattern generation unit 210a that generates a conversion efficiency deterioration correction pattern and a current amount deterioration correction pattern generation unit 210b that generates a current amount deterioration correction pattern. The correction computation unit 220 includes a conversion efficiency deterioration correction computation unit 221 that performs conversion efficiency deterioration correction and a current amount deterioration correction computation unit 222 that performs current amount deterioration correction. The correction pattern holding unit 230 includes a conversion efficiency deterioration correction pattern holding unit 231 that holds a conversion efficiency deterioration correction pattern and a current amount deterioration correction pattern holding unit 232 that holds a current amount deterioration correction pattern.

Here, it is assumed that the burn-in correction unit 200 shown in FIG. 6 uses the pixel characteristic of a pixel circuit in the initial state where no deterioration occurs as a reference for correction and corrects a gradation value of an input video signal so that the pixel characteristic of each of deteriorated pixel circuits 600 to 608 is identical to the reference. Moreover, it is assumed that the burn-in correction unit 200 updates information held by a pixel-based conversion efficiency deterioration amount integration unit 211 and a pixel-based current decrease amount integration unit 214 by acquiring the gradation value of a corrected video signal of each frame every minute. Furthermore, it is assumed that whenever the information held in the pixel-based conversion efficiency deterioration amount integration unit 211 and the pixel-based current decrease amount integration unit 214 is updated, a pixel-based conversion efficiency deterioration value calculation unit 212 and a pixel-based current amount deterioration calculation unit 215 generate new correction patterns.

Hereinafter, the respective units of the conversion efficiency deterioration correction pattern generation unit 210a and a current amount deterioration correction pattern generation unit 210b will be described.

The conversion efficiency deterioration correction pattern generation unit 210a includes the pixel-based conversion efficiency deterioration amount integration unit 211 and the pixel-based conversion efficiency deterioration value calculation unit 212 and generates a conversion efficiency deterioration correction pattern. Here, the conversion efficiency deterioration correction pattern is a correction pattern including a correction value (conversion efficiency deterioration value) of the conversion efficiency deterioration for each of the pixel circuits 600 to 608 and is correction information for correcting the conversion efficiency deterioration.

The pixel-based conversion efficiency deterioration amount integration unit 211 holds information (conversion efficiency deterioration information) on deterioration of the conversion efficiencies of the pixel circuits 600 to 608 and sequentially updates the conversion efficiency deterioration information every prescribed update period. The conversion efficiency deterioration information is, for example, a value obtained by converting the amount of conversion efficiency deterioration of each of the pixel circuits 600 to 608 into an emission period at a specific gradation value. The converted value corresponds to an emission period required up to the occurrence of deterioration equivalent to the amount of conversion efficiency deterioration when a pixel is caused to emit light at a specific gradation value. The pixel-based conversion efficiency deterioration amount integration unit 211 calculates a new deterioration amount of the conversion efficiency of each of the pixel circuits 600 to 608 whenever the update period has been reached. The new deterioration amount means a deterioration amount occurring in each pixel circuit during the time between a previous update period and the present update period. For example, the new deterioration amount of the conversion efficiency of each of the pixel circuits 600 to 608 is calculated using an efficiency deterioration conversion coefficient based on a corrected video signal supplied from the correction computation unit 220. Here, the efficiency deterioration conversion coefficient is, for example, a coefficient for converting the deterioration amount of the light-emitting device 640 with the elapse of time based on an emission period and a gradation value set to a pixel circuit during emission. In this way, the new deterioration amount is added to the conversion efficiency deterioration information, and the conversion efficiency deterioration information is updated. The updated conversion efficiency deterioration information is supplied to the pixel-based conversion efficiency deterioration value calculation unit 212. As above, the new deterioration amount of each of the pixel circuits 600 to 608 calculated whenever the update period has been reached is sequentially added to the conversion efficiency deterioration information to thereby calculate a total deterioration amount of the conversion efficiencies of the pixel circuits 600 to 608 up to when the update period has been reached.

The pixel-based conversion efficiency deterioration value calculation unit 212 generates a conversion efficiency deterioration correction pattern and supplies the conversion efficiency deterioration correction pattern to the conversion efficiency deterioration correction pattern holding unit 231. The pixel-based conversion efficiency deterioration value calculation unit 212 sequentially acquires the conversion efficiency deterioration information of the pixel circuits 600 to 608, calculates the conversion efficiency of the pixel circuit using coefficient conversion information, and uses the calculated conversion efficiency as a target conversion efficiency value. Here, when a value converted into an emission period corresponding to a video signal of a specific gradation value is the conversion efficiency deterioration information, the coefficient conversion information is, for example, information representing the correlation between the emission period and the conversion efficiency. Moreover, a conversion efficiency of a pixel circuit in a correction reference state (for example, the initial state where no deterioration occurs) is used as a reference conversion efficiency value. Moreover, the calculated target conversion efficiency value and the reference conversion efficiency value are applied to Equation (4) to thereby calculate the conversion efficiency deterioration value ΔA. By the same procedure, the conversion efficiency deterioration value is calculated for all pixel circuits 600 to 608 to thereby generate conversion efficiency deterioration correction patterns.

The current amount deterioration correction pattern generation unit 210b includes the deterioration characteristic information generation unit 213, the pixel-based current decrease amount integration unit 214, and the pixel-based current amount deterioration calculation unit 215, and generates a current amount deterioration correction pattern. Here, the current amount deterioration correction pattern is a correction pattern including a correction value (current amount deterioration value) of the driving current decrease amount for each of the pixel circuits 600 to 608 and is correction information for correcting current amount deterioration.

The deterioration characteristic information generation unit 213 drives a dummy pixel circuit 609 by setting a plurality of levels of input gradation values to the dummy pixel circuit 609 every prescribed update period and measures the luminance value of the dummy pixel circuit 609 at that time. Moreover, the deterioration characteristic information generation unit 250 updates the deterioration characteristic information on deterioration of a luminance value due to a decrease in the driving current based on the measurement results. In addition, the dummy pixel circuit 609 is a pixel circuit which is not included in a display screen although it is a pixel circuit included in the pixel array unit 500. By using the dummy pixel circuit 609, it is possible to perform a measurement process without affecting the display screen even when the display device 100 is under operation. Moreover, when performing inspection, adjustment, or the like before shipment, pixel circuits constituting the display screen may be used as target pixel circuits, and the characteristics for each pixel circuit may be acquired. Moreover, the predetermined update cycle may be set to be the same as, or longer than, the update cycle (in this example, one minute) at which the pixel-based current decrease amount integration unit 214 calculates the current decrease amount. Since deterioration of a pixel circuit progresses slowly, it is sufficient to perform the update at a cycle of several hours or one day, for example.

The pixel-based current decrease amount integration unit 214 holds information on decrease in current amount of the driving current of each of the pixel circuits 600 to 608 as current amount decrease information and integrates a new decrease amount of the driving current of each of the pixel circuits 600 to 608 into the current amount decrease information to thereby update the current amount decrease information. Here, the current amount decrease information is, for example, a value obtained by converting the decrease amount of the driving current of each of the pixel circuits 600 to 608 into an emission period corresponding to a video signal of a specific gradation value. The pixel-based current decrease amount integration unit 214 calculates a new decrease amount of the driving current of each of the pixel circuits 600 to 608 whenever the update period has been reached. The new decrease amount means a decrease amount of a driving current occurring in each pixel circuit during the period from the previous update period and the present update period. For example, the pixel-based current decrease amount integration unit 214 calculates information on the new decrease amount of each of the pixel circuits 600 to 608 using decrease amount conversion coefficient based on the corrected video signal supplied from the correction computation unit 220. Here, the decrease amount conversion coefficient is, for example, a coefficient for converting the decrease amount of the driving current amount with the elapse of time based on an emission period and a gradation value during emission. The decrease amount conversion coefficient is calculated based on the deterioration characteristic information of the current amount generated by the deterioration characteristic information generation unit 213. Moreover, the new deterioration amount is sequentially added to the current amount decrease information to thereby update the current amount decrease information. The updated current amount decrease information is supplied to the pixel-based current amount deterioration calculation unit 215.

The pixel-based current amount deterioration calculation unit 215 generates a current amount deterioration correction pattern. The pixel-based current amount deterioration calculation unit 215 sequentially acquires the current amount decrease information of the pixel circuits 600 to 608. Moreover, the pixel-based current amount deterioration calculation unit 215 calculates the driving current decrease amount of the pixel circuit from the acquired current amount decrease information using decrease amount conversion information. The driving current decrease amount corresponds to ΔS in Equation (2). Here, when a value converted into an emission period at a specific gradation value is the current amount decrease information, the decrease amount conversion information is, for example, information representing the correlation between the emission period and the current amount decrease information. Moreover, the driving current decrease amount calculated for a target pixel circuit using the current amount decrease information is used as a target current amount decrease amount. Moreover, in order to generate a current amount deterioration correction pattern, a current amount deterioration value for each of the pixel circuits 600 to 608 is calculated based on the target current amount decrease amount. For example, when a driving current decrease amount is supplied as the target current amount decrease amount, the driving current decrease amount is supplied as a current amount deterioration value. Here, the current amount deterioration value is a value used for eliminating a difference in driving current decrease amount between a correction target pixel circuit and a correction reference pixel circuit, which occurs when the gradation value of a video signal supplied to a pixel circuit serving as a correction target of the driving current decrease amount is changed. By the same procedure, the current amount deterioration value is calculated for all pixel circuits 600 to 608 to thereby generate current amount deterioration correction patterns.

Next, the correction computation unit 220 will be described. The correction computation unit 220 corrects an input video signal and supplies the corrected video signal to the horizontal selector (HSEL) 420 through the signal line 209. Moreover, the corrected video signal is supplied to the pixel-based conversion efficiency deterioration amount integration unit 211 and the pixel-based current decrease amount integration unit 214. Here, the respective units of the correction computation unit 220 will be described.

The conversion efficiency deterioration correction computation unit 221 corrects a conversion efficiency deterioration by changing the gradation value of a video signal input through the signal line based on a conversion efficiency deterioration correction pattern supplied from the conversion efficiency deterioration correction pattern holding unit 231. Moreover, the conversion efficiency deterioration correction computation unit 221 supplies the corrected video signal to the current amount deterioration correction computation unit 222.

The current amount deterioration correction computation unit 222 corrects a driving current decrease amount by changing the gradation value of a video signal output from the conversion efficiency deterioration correction computation unit 221 based on a current amount deterioration correction pattern supplied from the current amount deterioration correction pattern holding unit 232. Moreover, the current amount deterioration correction computation unit 222 supplies the gradation value of the corrected video signal to the pixel-based conversion efficiency deterioration amount integration unit 211, the pixel-based current decrease amount integration unit 214, and the horizontal selector (HSEL) 420 through the signal line 209.

The correction pattern holding unit 230 will be described. The correction pattern holding unit 230 includes the conversion efficiency deterioration correction pattern holding unit 231 and the current amount deterioration correction pattern holding unit 232. The conversion efficiency deterioration correction pattern holding unit 231 holds conversion efficiency deterioration correction patterns including the conversion efficiency deterioration values of the respective pixel circuits, generated by the pixel-based conversion efficiency deterioration value calculation unit 212 and supplies the conversion efficiency deterioration correction patterns to the conversion efficiency deterioration correction computation unit 221. The current amount deterioration correction pattern holding unit 232 holds current amount deterioration correction patterns including current amount deterioration values of the respective pixel circuits, generated by the pixel-based current amount deterioration calculation unit 215 and supplies the current amount deterioration correction patterns to the current amount deterioration correction computation unit 222.

As above, by providing the conversion efficiency deterioration correction pattern generation unit 210a and the conversion efficiency deterioration correction computation unit 221, it is possible to correct the conversion efficiency deterioration of the pixel circuits 600 to 608. Moreover, by providing the current amount deterioration correction pattern generation unit 210b and the current amount deterioration correction computation unit 222, it is possible to perform correction on the decrease in the driving current of the pixel circuits 600 to 608. In this case, the decrease amount conversion coefficient used for calculating the current amount deterioration value is obtained by causing the dummy pixel circuit 609 to emit light at a plurality of levels of gradation values and measuring the deterioration of the dummy pixel circuit 609 due to the light emission. In this way, it is possible to perform a burn-in correction process with high accuracy taking the actual use state of the display device 100 into consideration. Moreover, in the above description, although the decrease amount conversion coefficient is obtained based on the measurement results, the efficiency deterioration conversion coefficient may be calculated based on the measurement results by the deterioration characteristic information generation unit 213. In this case, since the efficiency deterioration conversion coefficient represents the actual state, a burn-in correction process can be performed with higher accuracy.

In this example, although the video signal is acquired every one minute, and the information held in the pixel-based conversion efficiency deterioration amount integration unit 211 and the pixel-based current decrease amount integration unit 214 is updated, the present disclosure is not limited to this. The acquisition intervals of the video signal can be determined appropriately. For example, a corrected video signal may be acquired every ten minutes, and the conversion efficiency deterioration information maybe updated assuming that light is emitted for ten minutes in accordance with the acquired video signal. By setting the update intervals of the conversion efficiency deterioration information to be relatively long, it is possible to further decrease the amount of computation. Moreover, by setting the acquisition intervals to be short, the information may be updated with higher accuracy. Furthermore, the update cycle of the correction patterns by the conversion efficiency deterioration correction pattern generation unit 210a and the current amount deterioration correction pattern generation unit 210b may not be the same as the update cycle of the information held in the pixel-based conversion efficiency deterioration amount integration unit 211 and the pixel-based current decrease amount integration unit 214. Even when the luminance fluctuates from one pixel circuit to another, since the deterioration of a pixel circuit progresses slowly, the conversion efficiency deterioration correction pattern and the current amount deterioration correction pattern are not abruptly updated to another pattern. Thus, for example, the amount of computation may be decreased by acquiring the conversion efficiency deterioration information and the current amount decrease information every one hour and updating the correction pattern every one hour based on the acquired information.

Next, a configuration example of the deterioration characteristic information generation unit 213 will be described. The deterioration characteristic information generation unit 213 measures the deterioration of a pixel circuit using the dummy pixel circuit 609.

### [Configuration Example of Deterioration Characteristic Information Generation Unit]

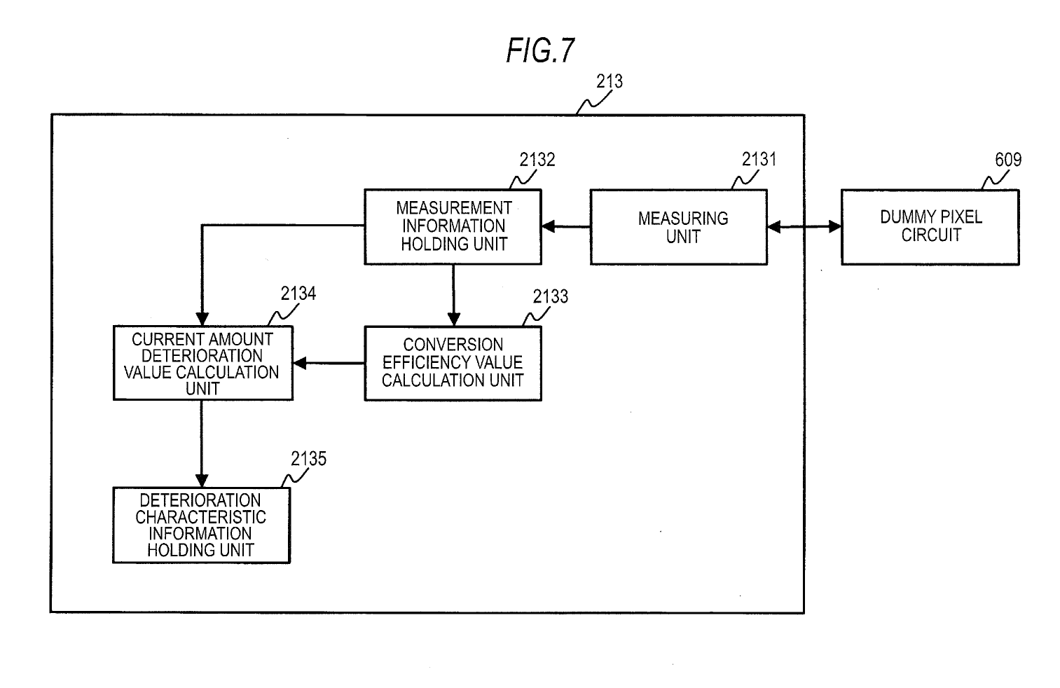

FIG. 7 is a diagram showing an example of a functional configuration of the deterioration characteristic information generation unit. The deterioration characteristic information generation unit 213 includes a measuring unit 2131, a measurement information holding unit 2132, a conversion efficiency value calculation unit 2133, a current amount deterioration value calculation unit 2134, and a deterioration characteristic information holding unit 2135. The deterioration characteristic information generation unit 213 calculates the current amount deterioration characteristic of the dummy pixel circuit 609 at a prescribed update cycle determined in advance. Since the deterioration of a pixel circuit progresses slowly, it is not necessary to set the update cycle to be short. The update cycle may be set to be further smaller than that of the pixel-based current decrease amount integration unit 214 and the pixel-based current amount deterioration calculation unit 215. However, in the example, it is assumed that the current amount deterioration characteristic is calculated at the same cycle as that of the pixel-based current decrease amount integration unit 214 and the pixel-based current amount deterioration calculation unit 215.

When an update cycle has been reached, the measuring unit 2131 sets a plurality of different levels of gradation values to the dummy pixel circuit 609 and measures the luminance of the dummy pixel circuit 609 when the respective gradation values are set thereto. Here, it is assumed that the gradation value set to the dummy pixel circuit 609 is a preset gradation value pattern regardless of the gradation value of a video signal. Moreover, the measuring unit 2131 generates measurement information in which the measured luminance value is correlated with a gradation value and supplies the measurement information to the measurement information holding unit 2132. In addition, the measuring unit 2131 sets a predetermined gradation value to the dummy pixel circuit 609 excluding a measurement period. In this way, the dummy pixel circuit 609 is driven with a gradation value at which deterioration characteristic is to be calculated, excluding the measurement period by the measuring unit 2131 to thereby obtain the deterioration characteristic when a pixel circuit is continuously used with a prescribed gradation value. Since the period for the measurement by the measuring unit 2131 is very short as compared to the driving period when the dummy pixel circuit 609 is driven with a prescribed gradation value, the effect of the measurement on the deterioration of the dummy pixel circuit 609 is negligible.

The measurement information holding unit 2132 holds the measurement information in which the luminance values corresponding to the plurality of levels of gradation values supplied from the measuring unit 2131 are registered. The measurement information is supplied to the conversion efficiency value calculation unit 2133 and the current amount deterioration value calculation unit 2134.

The conversion efficiency value calculation unit 2133 acquires the measurement information held by the measurement information holding unit 2132 and calculates the conversion efficiency value of the dummy pixel circuit 609. From Equation (2), the conversion efficiency value Ad of the pixel circuit can be calculated by the following equation based on the luminance value Ld and the driving current (S−ΔS)².

Ad=Ld/(S−ΔS)² (6)

Thus, the conversion efficiency value calculation unit 2133 reads a gradation value (Gin) corresponding to the measured luminance value (Ld) and the driving current from the measurement information holding unit 2132 and applies the same to Equation (6). Moreover, the conversion efficiency value calculation unit 2133 calculates the present conversion efficiency value Ad of the dummy pixel circuit 609. For example, the conversion efficiency value of the dummy pixel circuit 609 may be calculated by calculating the conversion efficiencies measured for the plurality of gradation values and performing statistical processing such as averaging.

Moreover, in the above calculation method, although AS is not taken into consideration, the conversion efficiency value Ad may be calculated taking AS into consideration. For example, the measuring unit 2131 measures the luminance values L1, L2, . . . , and Ln for a plurality of levels of gradation values. In this case, a driving current decrease amount ΔS of the same magnitude is included in the driving current values S1, S2, . . . , and Sn corresponding to the luminance values L1, L2, . . . , and Ln. Thus, the slope of a luminance value variation in relation to a driving current value variation (namely, “luminance value variation”/“driving current value variation”) is calculated based on the variation of driving current values S1, S2, . . . , and Sn between plural levels and the variation of the corresponding luminance values L1, L2, . . . ,and Ln. The conversion efficiency value calculated in this way does not include the effect of the driving current decrease amount ΔS, and a highly accurate conversion efficiency value can be obtained. The calculated conversion efficiency value is supplied to the current amount deterioration value calculation unit 2134.

The current amount deterioration value calculation unit 2134 calculates the driving current decrease amount ΔS of the driving current which decreases with deterioration of a pixel circuit as a current amount deterioration value based on the conversion efficiency value acquired from the conversion efficiency value calculation unit 2133. Thus, the current amount deterioration value calculation unit 2134 calculates a driving current value corresponding to a gradation value set to the dummy pixel circuit 609 based on the correlation between a luminance value and an efficiency conversion value measured for the gradation value. For example, from Equation (2), the driving current of a deteriorated pixel circuit can be expressed by the following equation.

(S−ΔS)²=Ld/Ad (7)

The luminance value correlated with the gradation value held in the measurement information holding unit 2132 and the conversion efficiency value calculated by the conversion efficiency value calculation unit 2133 are applied to Equation (7) to thereby calculate driving current values corresponding to the respective luminance values. The driving current value is correlated with a gradation value corresponding to the luminance value. In this way, it is possible to obtain the relationship between a gradation value and a driving current value (in fact, “luminance”/“conversion efficiency”) with respect to the dummy pixel circuit 609 in the present state. The characteristic of a driving current expressed by the relationship with the gradation value will be referred to as a deteriorated current characteristic. Similarly, the relationship between a gradation value and a driving current value when the dummy pixel circuit 609 is in the initial state which is a correction reference state is acquired. The characteristic of a driving current expressed by this relationship will be referred to as an initial current characteristic. Similarly to the above, a driving current value corresponding to a gradation value may be calculated from a conversion efficiency value and a luminance value in the initial state of the dummy pixel circuit 609 using Equation (1). Moreover, data of a gradation value and a driving current value may be registered as initial current characteristic characteristic information.

Subsequently, the current amount deterioration value calculation unit 2134 compares the calculated deteriorated current characteristic of the dummy pixel circuit 609 in the present state and the initial current characteristic of the dummy pixel circuit 609 in the initial state to thereby calculate the driving current decrease amount. Detailed procedure thereof will be described later.

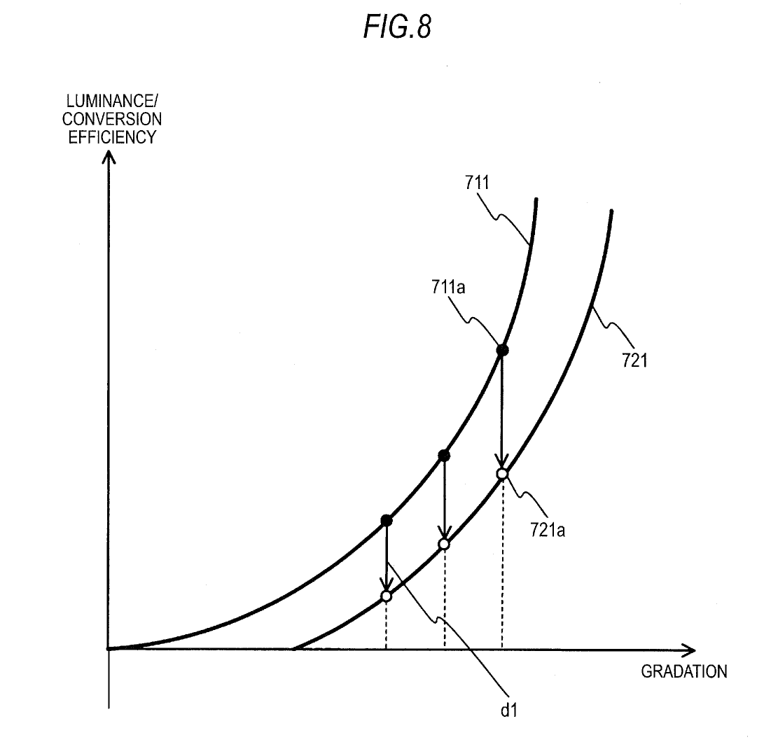

FIG. 8 is a graph showing the relationship between the current characteristic and a driving current decrease amount of a pixel circuit. In FIG. 8, the horizontal axis represents a gradation value, and the vertical axis represents a driving current value calculated by “luminance”/“conversion efficiency”.

A current characteristic curve (initial) 711 is a graph showing an initial current characteristic in the initial state where no deterioration occurs in a target pixel circuit. On the other hand, a current characteristic curve (deteriorated) 721 is a graph showing a deteriorated current characteristic in a state where current deterioration occurs in the target pixel circuit. The current amount deterioration value calculation unit 2134 compares a driving current value of the current characteristic curve (initial) 711 and a driving current value of the current characteristic curve (deteriorated) 721 at the same gradation value. For example, comparing a driving current value 711a in the initial state of the target pixel circuit and a driving current value 721a in the deterioration state of the target pixel circuit at the same gradation value, it can be understood that the driving current of the driving current value 721a in the deterioration state is decreased as compared to the driving current value 711a in the initial state. This is a driving current amount decrease component due to deterioration of a driving current. This value is calculated and used as a driving current decrease amount d1. Since the measurement is performed for a plurality of levels of gradation values, the accuracy of the driving current decrease amount d1 is increased by calculating the driving current decrease amount d1 with respect to the plurality of gradation values and performing statistical processing. The calculated driving current decrease amount is supplied to the deterioration characteristic information holding unit 2135 as a current amount deterioration value.

The deterioration characteristic information holding unit 2135 holds deterioration characteristic information and holds the deterioration characteristic information of the dummy pixel circuit 609 based on the measurement results obtained for the dummy pixel circuit 609. In this example, a current amount deterioration value calculated based on the measurement values measured for the dummy pixel circuit 609 every prescribed elapsed time is registered as the deterioration characteristic information so as to be correlated with the elapsed time.

As above, by calculating the current amount deterioration value based on a luminance value actually measured using the dummy pixel circuit 609, it is possible to obtain highly accurate current amount deterioration characteristic information. Moreover, when current amount deterioration correction is performed using the current amount deterioration characteristic information, it is possible to perform burn-in correction with high accuracy. In the above description, although the calculated conversion efficiency value is used solely for calculation of a driving current value, conversion efficiency deterioration characteristic information may be generated from the calculated conversion efficiency value. Since the conversion efficiency value is also calculated based on the luminance value actually measured using the dummy pixel circuit 609, it is possible to obtain a highly accurate conversion efficiency deterioration value based on the actual measurement values. Moreover, when current amount deterioration correction is performed using the conversion efficiency deterioration characteristic information based on the conversion efficiency deterioration value, it is possible to perform burn-in correction with higher accuracy.

Hereinafter, a generation example of the deterioration characteristic information in the burn-in correction unit 200 will be described with reference to drawings.

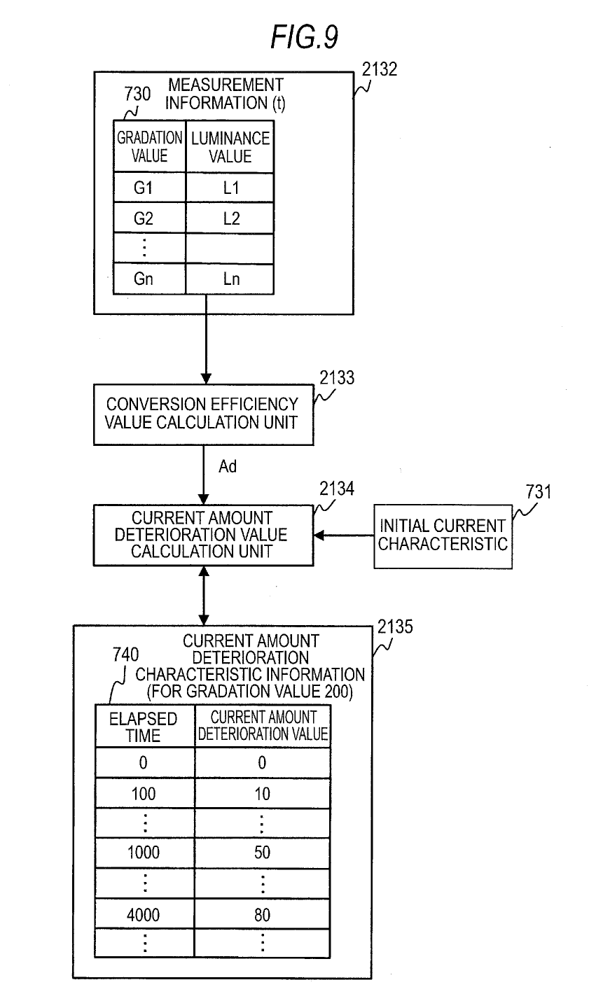

FIG. 9 is a diagram showing a generation example of the deterioration characteristic information. FIG. 9 schematically illustrates the flow up to when current amount deterioration characteristic information (for the gradation value 200) 740 held by the deterioration characteristic information holding unit 2135 is generated based on the measurement information 730 measured by the measuring unit 2131 and held by the measurement information holding unit 2132. In this example, a case in which the dummy pixel circuit 609 is driven with the gradation value of 200, and the deterioration characteristic information of the gradation value 200 is generated will be described.

The measurement information holding unit 2132 drives the dummy pixel circuit 609 with the gradation value of 200 from the initial state and holds measurement information (t) 730 measured by the measuring unit 2131 when a period of “t” has been elapsed. The measuring unit 2131 drives the dummy pixel circuit 609 with the gradation value of 200 excluding the measurement period. Moreover, when a prescribed update cycle has been reached, the measuring unit 2131 sets a plurality of levels of gradation values G1, G2, . . . , and Gn to the dummy pixel circuit 609 and measures the luminance at that time. In this way, the measuring unit 2131 supplies the measurement information (t) 730 in which the gradation values G1, G2, . . . , and Gn are correlated with the luminance values L1, L2, . . . , and Ln to the measurement information holding unit 2132.

The conversion efficiency value calculation unit 2133 reads the measurement information (t) 730 from the measurement information holding unit 2132 and calculates a conversion efficiency value from the gradation value and the luminance value. For example, the conversion efficiency value calculation unit 2133 calculates a variation (L2−L1) of the luminance value in relation to a variation (G2−G1) of the gradation value using Equation (2) to thereby calculate the conversion efficiency value Ad. The calculated conversion efficiency value Ad is supplied to the current amount deterioration value calculation unit 2134.

The current amount deterioration value calculation unit 2134 calculates a driving current value corresponding to a gradation value using the conversion efficiency value and the luminance value calculated by the conversion efficiency value calculation unit 2133. For example, as for the gradation value G1, the luminance value L1 and the conversion efficiency value Ad are applied to Equation (7), and a driving current value (L1/Ad) corresponding to the gradation value G1 is calculated. As for the gradation values G2, . . . , and Gn which are subjected to different measurements, the same procedure is performed to thereby calculate the driving current value (Ln/Ad). The deteriorated current characteristic in which the driving current value (Ln/Ad) obtained in this way is correlated with the gradation values G1, G2, . . . , and Gn is compared with the initial current characteristic 731 held in advance to thereby calculate the current amount deterioration value. Moreover, the calculated current value deterioration information is registered to the current amount deterioration characteristic information (for the gradation value 200) 740 held by the deterioration characteristic information holding unit 2135. In the current amount deterioration characteristic information (for the gradation value 200) 740, the calculated current amount deterioration value is set so as to be correlated with the elapsed time. In this example, the calculated current amount deterioration value is registered in a column corresponding to the “t” period. In addition, in the current amount deterioration characteristic information, a current amount deterioration value corresponding to an elapsed time is registered in advance in accordance with typical deterioration characteristic of a pixel circuit. Moreover, when the current amount deterioration value is calculated based on the luminance value measured using the dummy pixel circuit 609, the content in the corresponding column is updated with the calculated current amount deterioration value. Furthermore, a value obtained by converting a current deterioration amount into a gradation value may be used as the current deterioration value. In this case, a variation of a gradation value corresponding to the decrease in a driving current value from the initial state is registered in the current amount deterioration value of the current amount deterioration characteristic information (for the gradation value 200) 740.

The current amount deterioration characteristic information (for the gradation value 200) 740 held by the deterioration characteristic information holding unit 2135 is updated with the current amount deterioration value calculated based on the measurement values every prescribed update period.

In addition, conversion efficiency deterioration information regarding deterioration of a conversion efficiency may be generated from the conversion efficiency value calculated by the conversion efficiency value calculation unit 2133 and stored in the deterioration characteristic information holding unit 2135. For example, the calculated conversion efficiency value and a conversion efficiency value in the initial state of the dummy pixel circuit 609 are applied to Equation (4) to calculate a conversion efficiency deterioration value, and the conversion efficiency deterioration value is registered in the conversion efficiency deterioration information so as to be correlated with the elapsed time t.

The current amount deterioration characteristic information (for the gradation value 200) 740 held by the deterioration characteristic information holding unit 2135 in this way is used for calculation of the current amount decrease amount of the respective pixel circuits 600 to 608 by the pixel-based current decrease amount integration unit 214. Moreover, at the same time, when the conversion efficiency deterioration information is generated, the conversion efficiency deterioration information is used for calculation of the pixel circuit-based conversion efficiency deterioration amount by the pixel-based conversion efficiency deterioration amount integration unit 211.

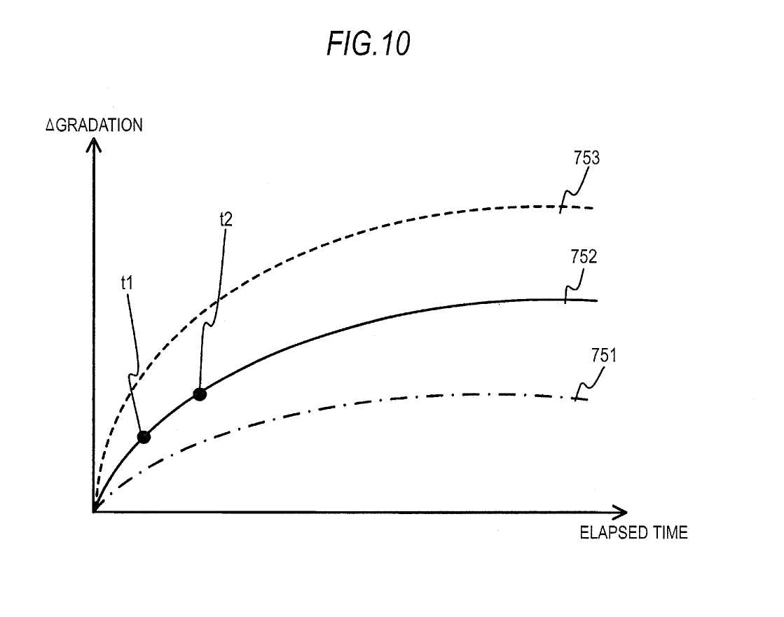

Next, the current amount deterioration characteristic information generated in the above procedure will be described. FIG. 10 is a graph showing an example of a current amount deterioration curve based on the current amount deterioration characteristic information. The horizontal axis of FIG. 10 represents the elapsed time from the initial state when the dummy pixel circuit 609 is driven. Moreover, the vertical axis represents a variation (ΔGradation) of the gradation value corresponding to the current amount deterioration value calculated by the current amount deterioration value calculation unit 2134.

A current amount deterioration curve (for the gradation value 100) 751 shows the relationship between the elapsed time and the ΔGradation corresponding to the current amount deterioration value when the dummy pixel circuit 609 is driven with the gradation value of 100. The gradation value 100 is a gradation value for causing the dummy pixel circuit 609 in the initial state to emit light at 100 nit.

A current amount deterioration curve (for the gradation value 200) 752 shows the relationship between the elapsed time and the ΔGradation corresponding to the current amount deterioration value when the dummy pixel circuit 609 is driven with the gradation value of 200. The gradation value 200 is a gradation value for causing the dummy pixel circuit 609 in the initial state to emit light at 200 nit.

A current amount deterioration curve (for the gradation value 400) 753 shows the relationship between the elapsed time and the ΔGradation corresponding to the current amount deterioration value when the dummy pixel circuit 609 is driven with the gradation value of 400. The gradation value 400 is a gradation value for causing the dummy pixel circuit 609 in the initial state to emit light at 400 nit.

For example, as described in the current amount deterioration characteristic information generation process shown in FIG. 9, when generating the current amount deterioration characteristic information for the gradation value 200, the current amount deterioration value calculation unit 2134 calculates the current amount deterioration values at the elapse time t1, t2, and the like. The current amount deterioration values are based on measurement data actually measured for the dummy pixel circuit 609 by the generation process shown in FIG. 9. Thus, by correcting the current amount deterioration curve (for the gradation value 200) 752 using the current amount deterioration values calculated at the elapsed time t1, t2, and the like, it is possible to obtain an accurate current amount deterioration curve matching the actual operation state fo the display device 100.

In addition, the current amount deterioration curve (for the gradation value 100) 751, the current amount deterioration curve (for the gradation value 200) 752, and the current amount deterioration curve (for the gradation value 400) 753 have correlation. For example, the time required for the current amount deterioration value at “gradation value 200” to deteriorate by a prescribed proportion (for example, 10 percents) has proportional relationship with the time required for 10 percents of the current amount deterioration value at “gradation value 100” to deteriorate similarly by the prescribed proportion. Thus, by holding the current amount deterioration characteristic information of one gradation value in the deterioration characteristic information holding unit 2135 as a master curve, it is possible to calculate the current amount deterioration values at other gradation values. For example, by holding the current amount deterioration curve (for the gradation value 200) 752, it is possible to calculate current amount deterioration values of the other current amount deterioration curve based on the proportional relationship between gradation values.

Next, a generation example of a conversion efficiency deterioration correction pattern and a generation example of a current amount deterioration correction pattern in the burn-in correction unit 200 having the above configuration will be described with reference to drawings.

### [Generation Example of Conversion Efficiency Deterioration Correction Pattern]

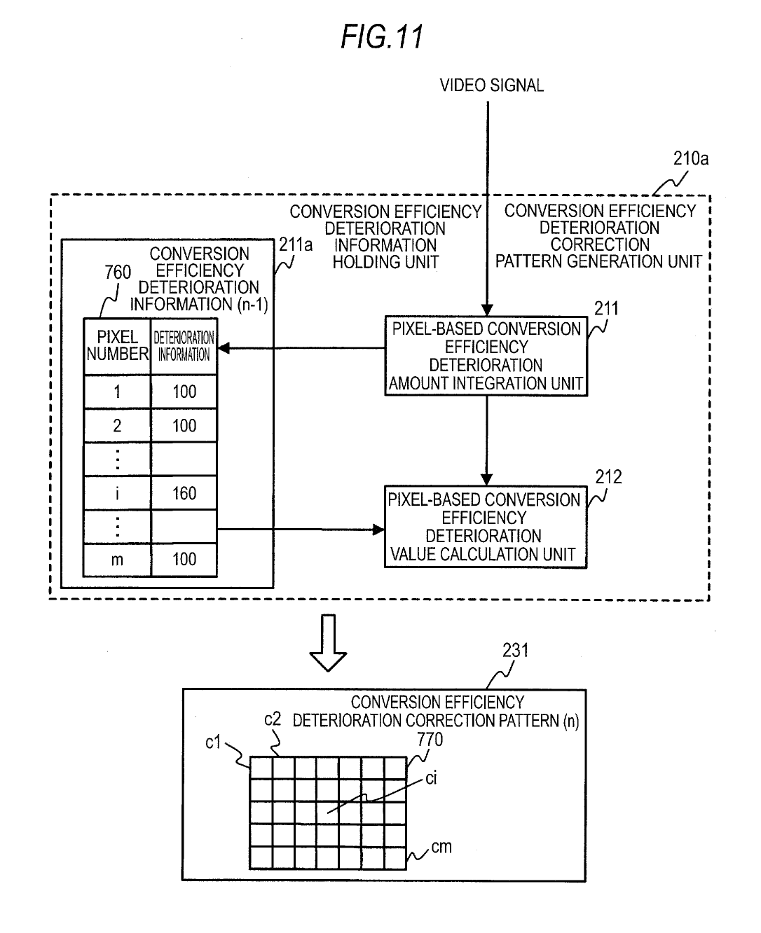

FIG. 11 is a diagram showing a generation of a conversion efficiency deterioration correction pattern. FIG. 11 schematically illustrates the flow up to when a conversion efficiency deterioration correction pattern (n) 770 held by the conversion efficiency deterioration correction pattern holding unit 231 is generated based on conversion efficiency deterioration information (n−1) 760 held by a conversion efficiency deterioration information holding unit 211a. Moreover, in FIG. 11, a storage unit that holds the conversion efficiency deterioration information in addition to the pixel-based conversion efficiency deterioration amount integration unit 211 and the pixel-based conversion efficiency deterioration value calculation unit 212 shown in FIG. 6 is described as the conversion efficiency deterioration information holding unit 211a. In addition, for the sake of convenience, pixel circuits provided in the display device 100 are identified by 1 to m. Here, the conversion efficiency deterioration correction pattern can be generated at the same cycle as, or a longer cycle than, the processing cycle at which the correction computation unit 220 processes a video signal. This is because deterioration progresses slowly even when the luminance fluctuates from one pixel circuit to another. For example, the amount of computation by the burn-in correction unit 200 can be decreased by updating the conversion efficiency deterioration correction pattern every one hour. However, in the following description, a case in which the conversion efficiency deterioration correction pattern is updated whenever the gradation value of a corrected video signal is output to a pixel circuit will be described.

The pixel-based conversion efficiency deterioration amount integration unit 211 updates conversion efficiency deterioration information (n−1) 760 held in the conversion efficiency deterioration information holding unit 211a by adding, to the same, a new deterioration amount of the conversion efficiency of each of the pixel circuits 1 to m. Here, the conversion efficiency deterioration information (n−1) 760 is, for example, a value obtained by converting the amount of the conversion efficiency deterioration of each of the pixel circuits 1 to m into an emission period at a specific gradation value. For example, the pixel-based conversion efficiency deterioration amount integration unit 211 calculates new information on deterioration of the conversion efficiency of each of the pixel circuits 1 to m using an efficiency deterioration conversion coefficient based on the gradation value of a corrected video signal supplied from the correction computation unit 220. Here, the efficiency deterioration conversion coefficient is a coefficient for calculating the deterioration amount of the conversion efficiency of the light-emitting device 640 with the elapse of time based on an emission period and the gradation during emission.

The conversion efficiency deterioration information holding unit 211a holds, for each pixel circuit, the conversion efficiency deterioration information on deterioration of the luminance conversion efficiency of each of the pixel circuits 1 to m, supplied by the pixel-based conversion efficiency deterioration amount integration unit 211. The conversion efficiency deterioration information (n−1) 760 is held in the conversion efficiency deterioration information holding unit 211a as the conversion efficiency deterioration information based on the display during the (n−1)-th update cycle (where n is an integer of 2 or more). The conversion efficiency deterioration information (n−1) 760 is used for generating a conversion efficiency deterioration correction pattern (n) 770 for correcting the display during the n-th update cycle. A pixel number which is the number of a pixel circuit is held in the left column of the conversion efficiency deterioration information (n−1) 760, and the conversion efficiency deterioration information (the deterioration information) of the pixel circuit is held in the right column. For example, in this example, the conversion efficiency deterioration value is a value converted into the emission period (elapsed time) with the gradation value 200. For example, a period of “160” is held as the conversion efficiency deterioration information corresponding to the pixel number “i”, and a period of “100” is held as the conversion efficiency deterioration information corresponding to the pixels numbers “1”, “2”, and “m”.

In a state where such conversion efficiency deterioration information (n−1) 760 is held in the conversion efficiency deterioration information holding unit 211a, the pixel-based conversion efficiency deterioration value calculation unit 212 updates the n-th conversion efficiency deterioration correction pattern. First, the conversion efficiency deterioration information of a pixel circuit serving as a correction target is acquired, and the conversion efficiency of the pixel circuit is calculated and used as a target conversion efficiency value. For example, the process in which the target conversion efficiency value for the pixel number “1” is supplied to the pixel-based conversion efficiency deterioration value calculation unit 212 will be described. First, the pixel-based conversion efficiency deterioration value calculation unit 212 acquires the deterioration information “100” for the pixel number “1” from the conversion efficiency deterioration information (n−1) 760 and calculates the conversion efficiency using the coefficient conversion information. It is assumed that the coefficient conversion information is held in advance. Moreover, the pixel-based conversion efficiency deterioration value calculation unit 212 calculates the conversion efficiency deterioration value of the pixel circuit from the calculated conversion efficiency of the pixel circuit of the pixel number “1” and a reference efficiency deterioration value serving as a reference of correction and supplies the calculated conversion efficiency deterioration value to the conversion efficiency deterioration correction pattern holding unit 231. In this way, a conversion efficiency deterioration value corresponding to a conversion efficiency deterioration value “c1” of the conversion efficiency deterioration correction pattern (n) 770 is held in the conversion efficiency deterioration correction pattern holding unit 231.

Next, the conversion efficiency deterioration correction pattern (n) 770 held in the conversion efficiency deterioration correction pattern holding unit 231 in this way will be described.

The conversion efficiency deterioration correction pattern (n) 770 schematically shows a conversion efficiency deterioration correction pattern generated by the pixel-based conversion efficiency deterioration value calculation unit 212. FIG. 11 schematically shows an example of a conversion efficiency deterioration pattern when a conversion efficiency deterioration value for each pixel circuit, generated by the pixel-based conversion efficiency deterioration value calculation unit 212 is arranged so as to correspond to an arrangement of pixels constituting a display screen. Specifically, the conversion efficiency deterioration correction pattern (n) 770 is an example of a correction pattern including the conversion efficiency deterioration values generated based on the conversion efficiency deterioration information (n−1) 760 and is a correction pattern for correcting the gradation value of a video signal of each frame displayed during the n-th update cycle (1 minute).

The conversion efficiency deterioration value c1 in the conversion efficiency deterioration correction pattern (n) 770 is a conversion efficiency deterioration value for correcting a pixel circuit corresponding to a pixel number “1” shown in the conversion efficiency deterioration information (n−1) 760. Moreover, similarly to the conversion efficiency deterioration value c1, the conversion efficiency deterioration values c2, ci, and cm are conversion efficiency deterioration values for correcting the gradation value of a video signal supplied to the pixel circuits corresponding to the pixel numbers “2”, “i”, and “m” shown in the conversion efficiency deterioration information (n−1) 760.

In the correction computation unit 220, the conversion efficiency deterioration correction computation unit 221 corrects the gradation value of a video signal based on the conversion efficiency deterioration correction pattern (n) 770. For example, it is assumed that the conversion efficiency deterioration value ci of a pixel circuit corresponding to the pixel number “i” is larger than the conversion efficiency deterioration values c1, c2, and cm of pixel circuits corresponding to the other pixels numbers “1”, “2”, and “m”. In this case, the conversion efficiency deterioration correction computation unit 221 sets the correction amount (increment) of the gradation value of a video signal of a pixel circuit corresponding to the pixel number “i” so as to be larger than the correction amount (increment) of the gradation value of a video signal of pixel circuits corresponding to the other pixel numbers “1”, “2”, and “m”. By correcting the gradation value in this way, it is possible to correct burn-in.

As described above, the conversion efficiency deterioration correction pattern generation unit 210a generates a conversion efficiency deterioration correction pattern for changing the gradation value of a video signal displayed by a pixel circuit in accordance with the magnitude of a conversion efficiency deterioration value for each pixel circuit. Since the conversion efficiency deterioration values for all pixel circuits are set in the conversion efficiency deterioration correction pattern, it is possible to appropriately correct burn-in occurring in respective pixels which constitute a display screen.

### [Generation Example of Current Amount Deterioration Correction Pattern]

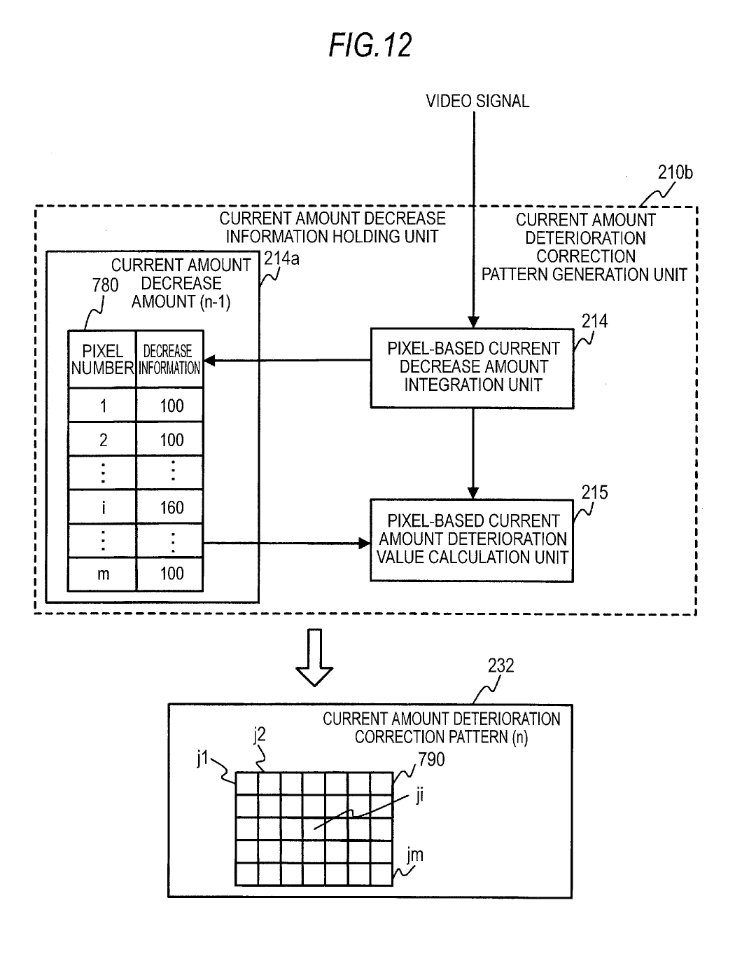

Next, a generation example of a current amount deterioration correction pattern by the current amount deterioration correction pattern generation unit 210b will be described. FIG. 12 is a diagram showing a generation example of a current amount deterioration correction pattern. FIG. 12 schematically shows the flow up to when a current amount deterioration correction pattern (n) 790 held by the current amount deterioration correction pattern holding unit 232 is generated based on current amount decrease information (n−1) 780 held by a current amount decrease information holding unit 214a. Moreover, in FIG. 12, a storage unit that holds the current amount decrease information in addition to the pixel-based current decrease amount integration unit 214 and the pixel-based current amount deterioration calculation unit 215 shown in FIG. 6 is described as the current amount decrease information holding unit 214a. In this example, similarly to the conversion efficiency deterioration correction pattern generation unit 210a shown in FIG. 11, pixel circuits provided in the display device 100 are identified by 1 to m. Moreover, a case in which the current amount deterioration correction pattern is updated whenever the gradation value of a corrected video signal is output to the pixel circuit will be described.

The current amount decrease information (n−1) 780 is information representing the decrease amount of a driving current of each pixel circuit, held in the current amount decrease information holding unit 214a. FIG. 12 shows an example of current amount decrease information held in the current amount decrease information holding unit 214a based on the display during the (n−1)-th update cycle as the current amount decrease information. The current amount decrease information (n−1) 780 is used for generating a current amount decrease correction pattern (n) for correcting the display during the n-th update cycle. A pixel number which is the number of a pixel circuit is held in the left column of the current amount decrease information (n−1) 780, and the current amount decrease information of the pixel circuit is held in the right column.

The pixel-based current decrease amount integration unit 214 updates the driving current decrease amount of each pixel circuit by adding a new driving current decrease amount of each of the pixel circuits 1 to m to the current amount decrease information (n−1) 780 held in the current amount decrease information holding unit 214a. Here, the current amount decrease information (n−1) 780 is, for example, a value obtained by converting the driving current decrease amount of each of the pixel circuits 1 to m into an emission period at a specific gradation value. For example, the pixel-based current decrease amount integration unit 214 calculates new information on the decrease amount of the driving current of each of the pixel circuits 1 to m using a decrease amount conversion coefficient based on the gradation value of a corrected video signal supplied from the correction computation unit 220. Here, the decrease amount conversion coefficient is a coefficient for calculating the decrease amount of the driving current of the light-emitting device 640 with the elapse of time based on an emission period and the gradation value set during emission. The decrease amount conversion coefficient can be calculated based on the current amount deterioration characteristic information (for the gradation value 200) 740 generated by the deterioration characteristic information generation unit 213. In the current amount deterioration characteristic information (for the gradation value 200) 740, the current amount deterioration value corresponding to the elapsed time when a pixel circuit is driven with the gradation value of 200 is registered as a master curve. Based on the master curve, a driving current decrease amount corresponding to an emission period of a target pixel circuit and the gradation value during emission is calculated.

The current amount decrease information holding unit 214a holds, for each pixel circuit, the current amount decrease information on the driving current decrease amount of each of the pixel circuits 1 to m, supplied by the pixel-based current decrease amount integration unit 214. The current amount decrease information (n−1) 780 is held in the current amount decrease information holding unit 214a based on the display during the (n−1)-th update cycle.

In a state where such current amount decrease information (n−1) 780 is held in the current amount decrease information holding unit 214a, the pixel-based current amount deterioration calculation unit 215 updates the n-th current amount deterioration correction pattern. First, the current amount decrease information of a pixel circuit serving as a correction target is acquired, and the new decrease amount of the driving current of the pixel circuit is calculated and used as a target current amount decrease amount. For example, the process in which the target current amount decrease amount for the pixel number “1” is supplied to the pixel-based current amount deterioration calculation unit 215 will be described. First, the pixel-based current amount deterioration calculation unit 215 acquires decrease information “100” for the pixel number “1” from the current amount decrease information (n−1) 780 and calculates a current decrease amount using the coefficient conversion information. It is assumed that the coefficient conversion information is held in advance. Moreover, the pixel-based current amount deterioration calculation unit 215 calculates the current amount deterioration value of the pixel circuit from the calculated current decrease value of the pixel circuit of the pixel number “1” and a reference current decrease value serving as a reference of correction and supplies the calculated current amount deterioration value to the current amount deterioration correction pattern holding unit 232. In this way, a current amount deterioration value corresponding to a current amount deterioration value “j1” of the current amount deterioration correction pattern (n) 790 is held in the current amount deterioration correction pattern holding unit 232.

Next, the current amount deterioration correction pattern (n) 790 held in the current amount deterioration correction pattern holding unit 232 in this way will be described.

The current amount deterioration correction pattern (n) 790 schematically shows a current amount deterioration correction pattern generated by the pixel-based current amount deterioration calculation unit 215. FIG. 12 schematically shows an example of a current amount deterioration correction pattern when a current amount deterioration value for each pixel circuit, generated by the pixel-based current amount deterioration calculation unit 215 is arranged so as to correspond to an arrangement of pixels constituting a display screen. Specifically, the current amount deterioration correction pattern (n) 790 is an example of a correction pattern including the current amount deterioration values generated based on the current amount decrease information (n−1) 780 and is a correction pattern for correcting the gradation value of a video signal of each frame displayed during the n-th processing period.

The current amount deterioration value j1 in the current amount deterioration correction pattern (n) 790 is a current amount deterioration value for correcting a pixel circuit corresponding to the pixel number “1” shown in the current amount decrease information (n−1) 780. Moreover, similarly to the current amount deterioration value j1, the current amount deterioration values j2, ji, and jm are current amount deterioration values for correcting the gradation value of a video signal supplied to the pixel circuits corresponding to the pixel numbers “2”, “i”, and “m” shown in the current amount decrease information (n−1) 780 similarly to the current amount deterioration value j1.

In the correction computation unit 220, the current amount deterioration correction computation unit 222 corrects the gradation value of a video signal based on the current amount deterioration correction pattern (n) 790. For example, it is assumed that the current amount deterioration value ji of a pixel circuit corresponding to the pixel number “i” is larger than the current amount deterioration values j1, j2, and jm of pixel circuits corresponding to the other pixel numbers “1”, “2”, and “m”. In this case, the current amount deterioration correction computation unit 222 sets the correction amount (increment) of the gradation value of a video signal of a pixel circuit corresponding to the pixel number “i” so as to be larger than the correction amount (increment) of the gradation value of a video signal of pixel circuits corresponding to the other pixel numbers “1”, “2”, and “m”. By correcting the gradation value in this way, it is possible to correct burn-in.

As described above, the current amount deterioration correction pattern generation unit 210b generates a current amount deterioration correction pattern for changing the gradation value of a video signal displayed by a pixel circuit in accordance with the magnitude of a driving current decrease amount for each pixel circuit. Since the current amount deterioration values for all pixel circuits are set in the current amount deterioration correction pattern, it is possible to appropriately correct burn-in occurring in respective pixels which constitute a display screen.

### [Operation Example of Burn-in Correction Unit]

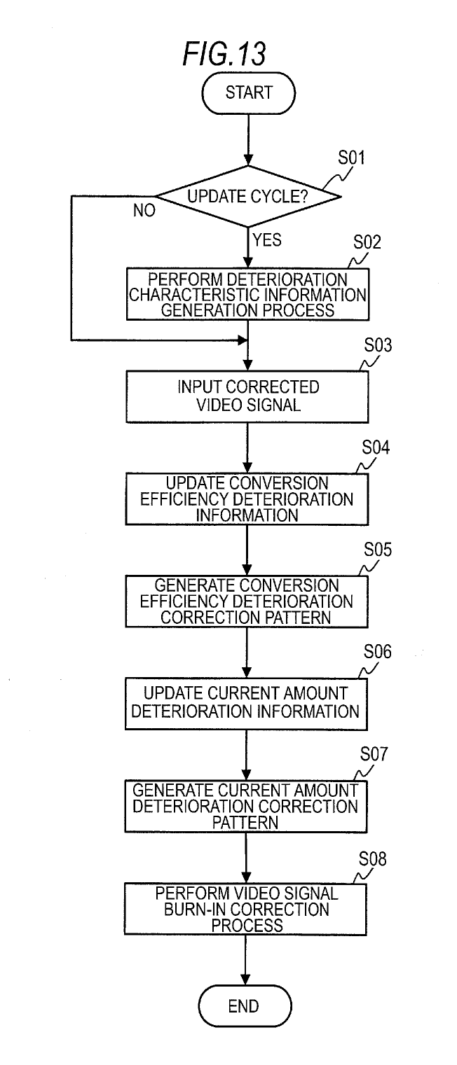

Next, the operation of the burn-in correction unit 200 will be described with reference to drawings. FIG. 13 is a flowchart showing an example of the procedure of a burn-in correction process by the burn-in correction unit. In the example of FIG. 13, it is assumed that the correction pattern generation process is performed at the same cycle as a video signal processing cycle. Moreover, it is assumed that a deterioration characteristic information generation process is performed at an update cycle which is an integer multiple of the video signal processing cycle.

The burn-in correction unit 200 is activated at the video signal processing cycle.

### [Step S01]

The deterioration characteristic information generation unit 213 determines whether a deterioration characteristic information update cycle has been reached. When the update cycle has been reached, the process proceeds to step S02. When the update cycle has not been reached, the process proceeds to step S03.

### [Step S02]

When the deterioration characteristic information update cycle has been reached, the deterioration characteristic information generation unit 213 updates the current amount deterioration characteristic information on the driving current using the dummy pixel circuit 609. Details of the process will be described later.

### [Step S03]

The conversion efficiency deterioration correction pattern generation unit 210a and the current amount deterioration correction pattern generation unit 210b acquire the gradation value of a corrected video signal output from the correction computation unit 220 at the previous video signal processing cycle and start respective processes.

### [Step S04]

The pixel-based conversion efficiency deterioration amount integration unit 211 of the conversion efficiency deterioration correction pattern generation unit 210a calculates a new deterioration amount of the conversion efficiency using the gradation value of the corrected video signal and updates the conversion efficiency deterioration information. For example, a new conversion efficiency deterioration amount of a pixel circuit during the elapsed time from the previous processing cycle and the present processing cycle is calculated using the gradation value of the corrected video signal and the efficiency deterioration conversion coefficient. Moreover, the new conversion efficiency deterioration amount is added to the conversion efficiency deterioration information of the target pixel circuit to thereby update the conversion efficiency deterioration information.

### [Step S05]

The pixel-based conversion efficiency deterioration value calculation unit 212 of the conversion efficiency deterioration correction pattern generation unit 210a generates a conversion efficiency deterioration correction pattern of each pixel based on the conversion efficiency deterioration information updated by the pixel-based conversion efficiency deterioration amount integration unit 211 and stores the conversion efficiency deterioration correction pattern in the conversion efficiency deterioration correction pattern holding unit 231.

### [Step S06]

The pixel-based current decrease amount integration unit 214 of the current amount deterioration correction pattern generation unit 210b calculates a new decrease amount of the driving current using the gradation value of the corrected video signal to thereby update the current amount decrease information. For example, a new driving circuit decrease amount of a pixel circuit during the elapsed time from the previous processing cycle and the present processing cycle is calculated using the gradation value of the corrected video signal and the decrease amount conversion coefficient. Here, the decrease amount conversion coefficient is calculated in advance based on the current amount deterioration characteristic information generated by the deterioration characteristic information generation unit 213. Moreover, the new driving current decrease amount is added to the current amount decrease information of the target pixel circuit to thereby update the current amount decrease information.

### [Step S07]

The pixel-based current amount deterioration calculation unit 215 of the current amount deterioration correction pattern generation unit 210b generates a current amount deterioration correction pattern of each pixel based on the current amount decrease information updated by the pixel-based current decrease amount integration unit 214 and stores the current amount deterioration correction pattern in the current amount deterioration correction pattern holding unit 232.

### [Step S08]

In the correction computation unit 220, the conversion efficiency deterioration correction computation unit 221 corrects the gradation value of an input video signal using the conversion efficiency deterioration correction pattern. Moreover, the current amount deterioration correction computation unit 222 corrects the corrected gradation value of the video signal using the current amount deterioration correction pattern.

By executing the above processing procedure, the conversion efficiency deterioration correction pattern and the current amount deterioration correction pattern are generated for the respective pixel circuits, and the conversion efficiency deterioration correction and the current amount deterioration correction are performed on the pixel circuits. In the above flowchart, although the current amount deterioration correction pattern generation unit 210b performs processing subsequently to the processing by the conversion efficiency deterioration correction pattern generation unit 210a, both processes may be performed in parallel.

### [Operation Example of Deterioration Characteristic Information Generation Unit]

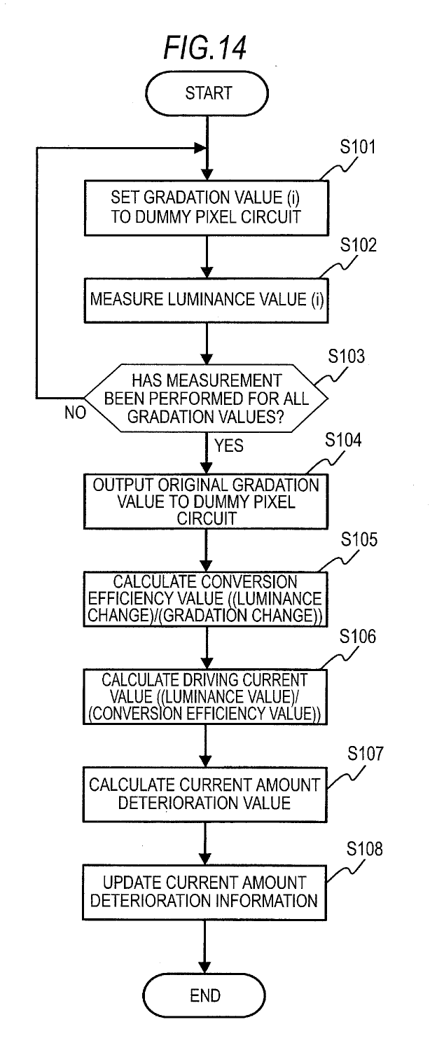

Next, the operation of the deterioration characteristic information generation unit 213 of the burn-in correction unit 200 will be described with reference to drawings. FIG. 14 is a flowchart showing an example of the procedure of a deterioration characteristic information generation process by the deterioration characteristic information generation unit.

### [Step S101]

The measuring unit 2131 sets a gradation value (i) to the dummy pixel circuit 609 based on a prescribed gradation value pattern. The gradation value (i) is the i-th gradation value of the gradation value pattern.

### [Step S102]

The measuring unit 2131 measures the luminance when the gradation value (i) is set to the dummy pixel circuit 609, and uses the measured luminance as a luminance value (i). Moreover, the measuring unit 2131 supplies the luminance value (i) to the measurement information holding unit 2132 so as to be correlated with the gradation value (i). Then, the measurement information holding unit 2132 holds the measurement information.

### [Step S103]

The measuring unit 2131 determines whether the measurement has been performed with respect to all gradation values set in the prescribed gradation pattern. When the measurement has not been performed for all gradation values, the variable “i” is increased, and the process returns to step S101, and measurement is performed for the next gradation value. When the measurement has been performed for all gradation values, the process proceeds to step S104.

### [Step S104]

The measuring unit 2131 sets the original gradation values, which were set to the dummy pixel circuit 609 before the measurement process starts, to the dummy pixel circuit 609. In this way, it is possible to obtain the current amount deterioration characteristic of a prescribed gradation value with the dummy pixel circuit 609. The measuring unit 2131 supplies the measurement information to the measurement information holding unit 2132, and the measurement information is held by the measurement information holding unit 2132.

### [Step S105]

The conversion efficiency value calculation unit 2133 calculates the conversion efficiency value of the dummy pixel circuit 609 during measurement based on the measurement information held by the measurement information holding unit 2132. For example, the conversion efficiency value calculation unit 2133 calculates “luminance variation”/“gradation value variation” based on the plurality of levels of gradation values registered in the measurement information and the luminance values corresponding to the gradation values to thereby calculate the conversion efficiency value. The calculated conversion efficiency value is supplied to the current amount deterioration value calculation unit 2134. Moreover, the deterioration amount of the conversion efficiency from the initial state may be calculated based on the conversion efficiency value (initial) in the initial state of the dummy pixel circuit 609. The calculated deterioration amount of the conversion efficiency is stored in the deterioration characteristic information holding unit 2135 as the conversion efficiency deterioration characteristic information.

### [Step S106]

The current amount deterioration value calculation unit 2134 calculates “luminance value”/“conversion efficiency value” corresponding to the driving current value using the conversion efficiency value of the dummy pixel circuit 609 during measurement, calculated by the conversion efficiency value calculation unit 2133 and the luminance value of the measurement information. Moreover, the current amount deterioration value calculation unit 2134 correlates the calculated driving current value (“luminance value”/“conversion efficiency value”) with the gradation value corresponding to the luminance value to thereby calculate the deteriorated current characteristic.

### [Step S107]

The current amount deterioration value calculation unit 2134 compares the calculated deteriorated current characteristic with the initial current characteristic in the initial state of the dummy pixel circuit 609 to thereby calculate the decrease amount of the driving current. The calculated driving current decrease amount is used as the current amount deterioration value.

### [Step S108]

The current amount deterioration value calculation unit 2134 updates the current amount deterioration characteristic information in which the driving period of the dummy pixel circuit 609 and the current amount deterioration value are correlated with each other based on the calculated current amount deterioration value and the measurement time. The updated current amount deterioration characteristic information is supplied to the deterioration characteristic information holding unit 2135, and the deterioration characteristic information holding unit 2135 holds the current amount deterioration characteristic information.

By executing the above processing procedure, the current amount deterioration characteristic information is updated based on the luminance values measured by setting a plurality of levels of gradation values to the dummy pixel circuit 609. In this way, it is possible to obtain highly accurate current amount deterioration characteristic information based on the actually measured values. Moreover, by correcting the gradation value of a video signal based on the highly accurate current amount deterioration characteristic information, it is possible to perform burn-in correction with high accuracy.

The display device 100 described can be applied to a display which has a flat panel shape and is included in any of various kinds of electronic apparatus such as, for example, a digital camera, a notebook personal computer, a cellular phone, or a video camera. Specifically, the display device can be applied to a display of electronic apparatus in any field, capable of displaying a video signal input to the electronic apparatus or generated in the electronic apparatus as an image or a video. Examples of an electronic apparatus to which such a display device 100 is applied will be described below.

### [Application Example to Electronic Apparatus]

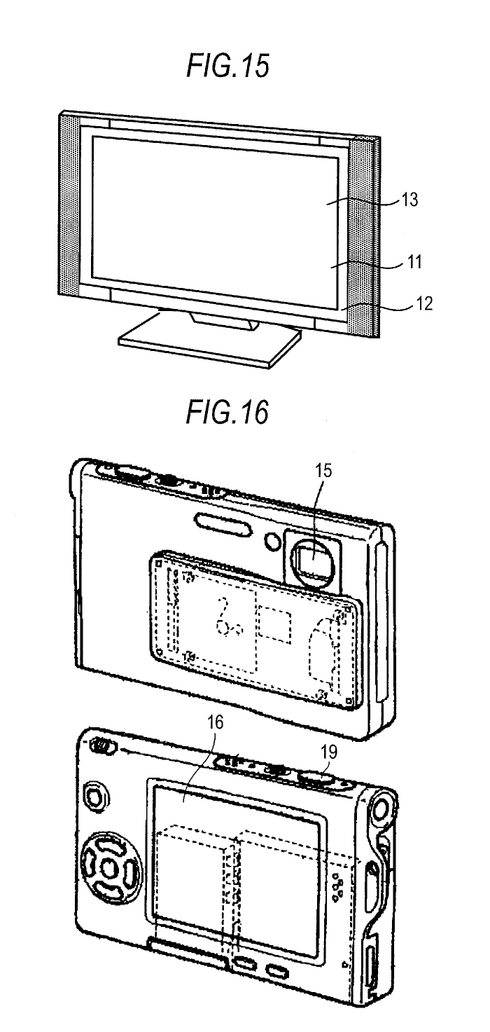

FIG. 15 is a perspective view showing a television set including the display device according to the embodiment of the present disclosure. The television set shown in FIG. 15 includes a video display screen 11 including a front panel 12, a filter glass 13, and the like, and is manufactured by using the display device 100 as the video display screen 11.

FIG. 16 is a perspective view showing a digital still camera including the display device according to the embodiment of the present disclosure. In FIG. 16, the front view of the digital still camera is shown on the upper part, and the rear view of the digital still camera is shown on the lower part. The digital still camera shown in FIG. 16 includes an imaging lens, a flash light emitter 15, a display unit 16, a control switch, a menu switch, a shutter button 19, and the like, and is manufactured by using the display device 100 as the display unit 16.

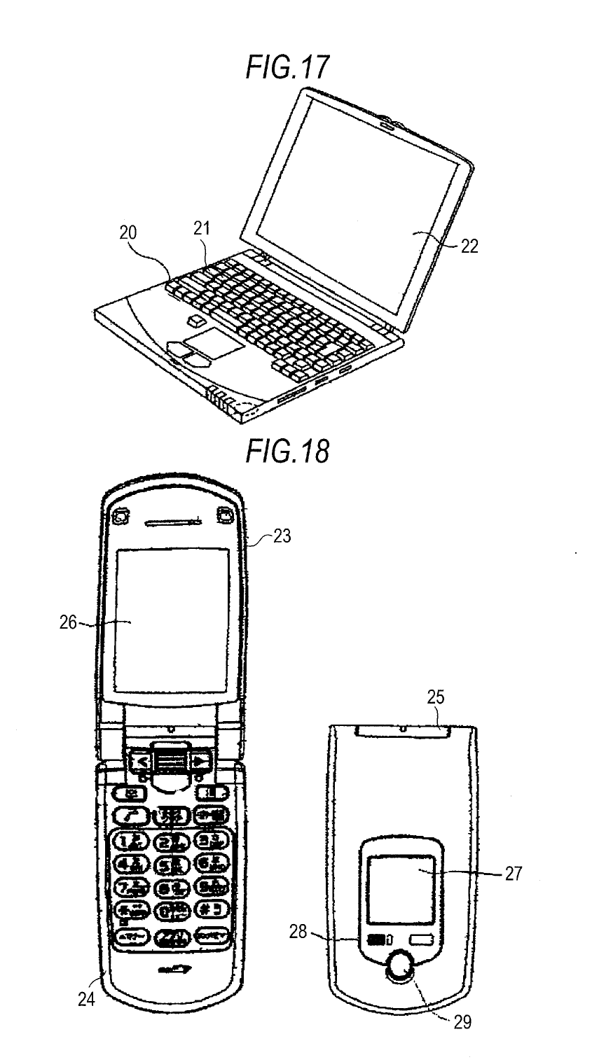

FIG. 17 is a perspective view showing a notebook personal computer including the display device according to the embodiment of the present disclosure. The notebook personal computer shown in FIG. 17 includes a main body 20, a keyboard 21 that is included in the main body 20 and operated when inputting characters and the like, and a display unit 22 which is included in a main body cover so as to display an image. The notebook personal computer is manufactured by using the display device 100 as the display unit 22.

FIG. 18 is a schematic view showing a portable terminal including the display device according to the embodiment of the present disclosure. In FIG. 18, the open state of the portable terminal is shown on the left side, and the closed state of the portable terminal is shown on the right side. The portable terminal shown in FIG. 18 includes an upper housing 23, a lower housing 24, a connecting portion (in this example, a hinge) 25, a display 26, a sub-display 27, a picture light 28, a camera 29, and the like. The portable terminal is manufactured by using the display device 100 as the display 26 or the sub-display 27.

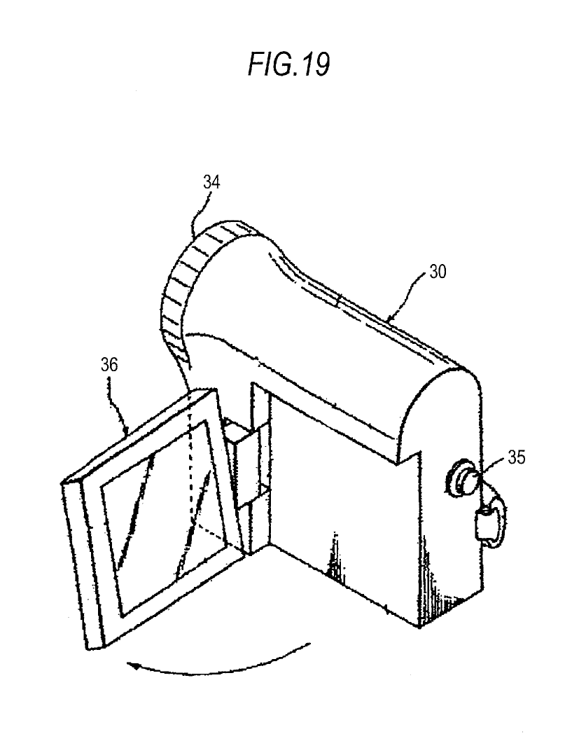

FIG. 19 is a perspective view showing a video camera including the display device according to the embodiment of the present disclosure. The video camera shown in FIG. 19 includes a main body portion 30, a lens 34 that is disposed on a side surface facing the front side and used for photographing a subject, a switch 35 for starting and stopping photography, a monitor 36, and the like. The video camera is manufactured by using the display device 100 as the monitor 36.

According to the electronic apparatuses described above, since deterioration components of conversion efficiency, in particular, can be obtained with high accuracy, it is possible to resolve burn-in with high accuracy.

The processing functions described above can be realized by a computer. In this case, a program describing the processing content of functions which are to be included in a signal processing device, a display device, and an electronic apparatus is provided. When the program is executed by a computer, the processing functions are realized on the computer. The program describing the processing content maybe recorded on a computer-readable recording medium. Examples of the computer-readable recording medium include a magnetic storage device, an optical disc, an opto-magnetic recording medium, and a semiconductor memory. Examples of the magnetic storage device include a hard disk device (HDD), a flexible disk (FD), and a magnetic tape. Examples of the optical disc include a DVD, a DVD-RAM, a CD-ROM/RW. Examples of the opto-magnetic recording medium include a MO (Magneto-Optical disc).

When distributing the program, for example, a portable recording medium such as a DVD or a CD-ROM in which the program is recorded is sold. Moreover, the program may be stored in a storage device of a server computer so that the program can be transmitted from the server computer to another computer through a network.

The computer executing the program stores, for example, the program recorded on a portable recording medium or the program transmitted from the server computer in a subject storage device. Then, the computer reads the program from the subject storage device and executes processes in accordance with the program. In addition, the computer may read the program directly from a portable recording medium and execute processes in accordance with the program. Moreover, the computer may sequentially execute processes in accordance with the received program whenever the program is transmitted from the server computer connected through a network.

Moreover, at least part of the processing functions described above may be realized by an electronic circuit such as a DSP (Digital Signal Processor), an ASIC, or a PLD (Programmable Logic Device).

The present disclosure contains subject matter related to that disclosed in Japanese Priority Patent Application JP 2010-291842 filed in the Japan Patent Office on Dec. 28, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a measuring unit that measures an actual luminance of a prescribed pixel circuit having a light-emitting device every prescribed update period by setting a plurality of levels of gradation values indicating the degree of light emission of the light-emitting device to thereby generate measurement information in which the gradation value and the measured luminance value are correlated with each other;
a conversion efficiency value calculation unit that calculates a conversion efficiency value for the light-emitting device of the prescribed pixel circuit to convert a driving current supplied in accordance with a gradation value into a luminance based on the relationship between the measured luminance value and a gradation value corresponding to the luminance value; and
a current amount deterioration value calculation unit that calculates a driving current corresponding to the measured luminance value using the conversion efficiency value, compares the relationship between the driving current and a gradation value corresponding to the luminance value with the relationship between a driving current and a gradation value when the prescribed pixel circuit is in a correction reference state to thereby calculate a current amount deterioration value regarding deterioration of a driving current of the prescribed pixel circuit, and generates current amount deterioration characteristic information of the prescribed pixel circuit.

2. The signal processing device according to claim 1,
wherein the current amount deterioration value calculation unit calculates the current amount deterioration value by calculating a difference between a driving current value of the prescribed pixel circuit in the prescribed update period and a reference driving current value when the prescribed pixel circuit is in a reference state, generated at the same gradation value based on a deteriorated pixel characteristic calculated for the prescribed pixel circuit and a reference pixel characteristic when the prescribed pixel circuit is in the correction reference state.

3. The signal processing device according to claim 1,
wherein the current amount deterioration value calculation unit stores current amount deterioration characteristic information, in which an elapsed time accumulated from the correction reference state is correlated with an estimated value of a current amount deterioration value in the prescribed update period when the prescribed pixel circuit is driven with a certain gradation value with the timepoint at which the prescribed pixel circuit is the correction reference state being a start point, in advance in a deterioration characteristic information holding unit and updates the current amount deterioration characteristic information held in the deterioration characteristic information holding unit in accordance with the current amount deterioration value based on the calculated current amount deterioration value.

4. The signal processing device according to claim 1,
further comprising a dummy pixel circuit which can be driven by setting a gradation value of an optional magnitude thereto,
wherein the measuring unit uses the dummy pixel circuit as the prescribed pixel circuit.

5. A signal processing method comprising:
measuring an actual luminance of a prescribed pixel circuit having a light-emitting device every prescribed update period by setting a plurality of levels of gradation values indicating the degree of light emission of the light-emitting device to thereby generate measurement information in which the gradation value and the measured luminance value are correlated with each other;
calculating a conversion efficiency value for the light-emitting device of the prescribed pixel circuit to convert a driving current supplied in accordance with a gradation value into a luminance based on the relationship between the measured luminance value and a gradation value corresponding to the luminance value; and
calculating a driving current corresponding to the measured luminance value using the conversion efficiency value, comparing the relationship between the driving current and a gradation value corresponding to the luminance value with the relationship between a driving current and a gradation value when the prescribed pixel circuit is in a correction reference state to thereby calculate a current amount deterioration value regarding deterioration of a driving current of the prescribed pixel circuit, and generating current amount deterioration characteristic information of the prescribed pixel circuit.

6. A signal processing method comprising:
measuring a luminance of alight-emitting device of a prescribed pixel circuit having the light-emitting device every prescribed update period;
calculating a conversion efficiency value for the light-emitting device of the prescribed pixel circuit to convert a driving current supplied thereto into a luminance; and
calculating a driving current corresponding to the measured luminance using the conversion efficiency value and comparing the relationship between the driving current and a gradation value corresponding to the luminance with the relationship between a driving current and a gradation value in a reference state of the prescribed pixel circuit.

7. A display device comprising:
a plurality of pixel circuits each including a light-emitting device;
a measuring unit that measures an actual luminance of a prescribed pixel circuit having a light-emitting device every prescribed update period by setting a plurality of levels of gradation values indicating the degree of light emission to the pixel circuit to thereby generate measurement information in which the gradation value and the measured luminance value are correlated with each other;
a conversion efficiency value calculation unit that calculates a conversion efficiency value for the light-emitting device of the prescribed pixel circuit to convert a driving current supplied in accordance with a gradation value into a luminance based on the relationship between the measured luminance value and a gradation value corresponding to the luminance value;
a current amount deterioration value calculation unit that calculates a driving current corresponding to the measured luminance value using the conversion efficiency value, compares the relationship between the driving current and a gradation value corresponding to the luminance value with the relationship between a driving current and a gradation value when the prescribed pixel circuit is in a correction reference state to thereby calculate a current amount deterioration value regarding deterioration of a driving current of the prescribed pixel circuit, and generates current amount deterioration characteristic information of the prescribed pixel circuit;
a correction computation unit that calculates current amount deterioration values of the plurality of pixel circuits based on the current amount deterioration characteristic information, and corrects the gradation value of a video signal instructed with respect to the plurality of pixel circuits based on the current amount deterioration values.

8. An electronic apparatus comprising:
a plurality of pixel circuits each including a light-emitting device;
a measuring unit that measures an actual luminance of a prescribed pixel circuit having a light-emitting device every prescribed update period by setting a plurality of levels of gradation values indicating the degree of light emission of the light-emitting device to thereby generate measurement information in which the gradation value and the measured luminance value are correlated with each other;
a conversion efficiency value calculation unit that calculates a conversion efficiency value for the light-emitting device of the prescribed pixel circuit to convert a driving current supplied in accordance with a gradation value into a luminance based on the relationship between the measured luminance value and a gradation value corresponding to the luminance value;
a current amount deterioration value calculation unit that calculates a driving current corresponding to the measured luminance value using the conversion efficiency value, compares the relationship between the driving current and a gradation value corresponding to the luminance value with the relationship between a driving current and a gradation value when the prescribed pixel circuit is in a correction reference state to thereby calculate a current amount deterioration value regarding deterioration of a driving current of the prescribed pixel circuit, and generates current amount deterioration characteristic information of the prescribed pixel circuit;
a correction computation unit that calculates current amount deterioration values of the plurality of pixel circuits based on the current amount deterioration characteristic information, and corrects the gradation value of a video signal instructed with respect to the plurality of pixel circuits based on the current amount deterioration values.
